(19) United States
(12) Patent Application Publication
(10) Pub. No.: US 2020/0265379 A1
(43) Pub. Date: Aug. 20, 2020

(54) SYSTEMS, METHODS, AND INTERFACES FOR TRANSACTION AGGREGATION, MANAGEMENT, AND VISUALIZATION

(71) Applicant: ROUTE APP LLC, Lehi, UT (US)

(72) Inventors: Evan Walker, Lehi, UT (US); Mike Moreno, Lehi, UT (US)

(21) Appl. No.: 16/748,798

(22) Filed: Jan. 21, 2020

Related U.S. Application Data
(60) Provisional application No. 62/794,273, filed on Jan. 18, 2019.

(51) Int. Cl. G06Q 10/08; G06N 20/00; G06Q 30/06

(52) U.S. Cl. CPC G06Q 10/0833; G06Q 30/0635; G06N 20/00

(57) ABSTRACT

A transaction service acquires information pertaining to transactions between a user and respective ecommerce systems, and shipments associated with the transactions (the shipments handled by respective carriers). The transaction service generates an aggregated transaction dataset comprising information pertaining to a plurality of transactions. The aggregated transaction dataset may comprise an aggregation of transaction data extracted from a plurality of different data sources (each data source having a different configuration). The aggregated transaction dataset is displayed in a graphical user interface, such that the graphical user interface comprises visual representations of transactions spanning a plurality of different vendors and/or a plurality of different carriers.

The Application Data Sheet filed with this application is incorporated by reference herein. Any applications claimed on the ADS for priority under 35 U.S.C. §§ 119, 120, 121, or 365(c), and any and all parent, grandparent, great-grandparent, etc., applications of such applications, are also incorporated by reference, including any priority claims made in those applications and any material incorporated by reference, to the extent such subject matter is not inconsistent herewith.

### CROSS-REFERENCE TO RELATED APPLICATIONS

This application claims priority to U.S. provisional patent application Ser. No. 62/794,273, filed Jan. 18, 2019, which is incorporated by reference, to the extent such subject matter is not inconsistent herewith.

### TECHNICAL FIELD

This disclosure relates to managing distributed transactions and, in particular, to systems, methods, apparatus, and interfaces for managing and/or visualizing transaction shipments corresponding to transactions with a plurality of different vendors and/or handled by a plurality of different carriers.

### BACKGROUND

Information pertaining to transactions involving a user, and shipments corresponding to the transactions, may be maintained in a plurality of different sources, each having a different respective configuration and/or access protocol. Moreover, the transactions, and corresponding shipping information, may be associated with a plurality of different accounts, e.g., a user may register different accounts and/or identifiers (email addresses) with different vendors. Thus it may be difficult, or even impossible, to manage and/or visualize user transactions through a single interface. What is needed, therefore, are systems, methods, and/or interfaces for acquiring information pertaining to user transactions from a plurality of different sources, aggregating the transaction information, and providing an efficient, easy-to-digest visual representation of the aggregated transaction information (e.g., presenting transaction information spanning a plurality of different vendors and/or a plurality of different carriers in a single interface).

### BRIEF DESCRIPTION OF THE DRAWINGS

FIG. 1 is a schematic block diagram of one embodiment of a system for managing user transactions, as disclosed herein.

FIG. 2A is a schematic block diagram of one embodiment of a client computing device configured to display an interface configured to visually represent transactions corresponding to a plurality of different vendors and/or a plurality of different carriers, as disclosed herein.

FIG. 2B depicts embodiments of an interface for visualizing a plurality of transactions spanning a plurality of different vendors and/or a plurality of different carriers, as disclosed herein.

FIG. 2C depicts further embodiments of an interface a plurality of transactions spanning a plurality of different vendors and/or a plurality of different carriers, as disclosed herein.

FIG. 3 is a flow diagram of one embodiment of a method for aggregating, managing and/or visualizing transactions involving a user, as disclosed herein.

FIG. 4 is a flow diagram of another embodiment of a method for managing user transactions, as disclosed herein.

FIG. 5 is a flow diagram of one embodiment of a method for visualizing user transactions corresponding to a plurality of different vendors and/or carriers, as disclosed herein.

FIG. 6 is a flow diagram of another embodiment of a method for visualizing user transactions corresponding to a plurality of different vendors and/or carriers, as disclosed herein.

### DETAILED DESCRIPTION

As disclosed above, information pertaining to transactions between users and respective vendors (and shipments corresponding to such transactions) may be maintained in a different sources, each having a different respective configuration. A user may enter into transactions with a plurality of different vendors (e.g., may make purchases from a plurality of different ecommerce storefronts). The vendors may be configured to provide the user with information pertaining to the transactions, such as transaction confirmations, receipts (e.g., receipts for payments made pursuant to respective transactions), shipment confirmations, delivery confirmations, and/or the like. Vendors may communicate transaction information to the user via respective means: vendors may communicate transaction information to the user in messages sent to user-specified endpoints (e.g., email, text messaging, instant messaging, and/or the like), may provide an online portal through which the user may access transaction information, and/or the like. The transaction information provided by different vendors may have different configurations, which may make it difficult to aggregate and/or combine information pertaining to user transactions that span multiple different vendors (e.g., each vendor may communicate and/or represent transaction information in accordance with different respective layout, structure, format, schema, encoding, data representation, namespace, access protocol, and/or the like). Moreover, transaction information from different vendors may be associated with different user-vendor accounts (each user-vendor account corresponding to an account of the user with a respective vendor) and/or be sent to different endpoints, making it even more difficult, or even impossible, to efficiently aggregate and/or combine distributed user transaction information (e.g., information pertaining to user transactions with a first vendor may be sent to a first email address and represent user transaction information in accordance with a first configuration, information pertaining to transactions with a second vendor may be sent to a second email address and represent user transaction information in accordance with a second format, information pertaining to transactions with a third vendor may be sent as text messages and represent user transaction information in accordance with a third format, and so on).

The transaction information provided by the respective vendors may comprise information pertaining to respective transaction shipments. As used herein, a “transaction shipment” refers to a shipment associated with a transaction (e.g., a shipment comprising items purchased in the transaction). The transaction information provided by respective vendors may identify the carriers assigned to handle respective transaction shipments and/or specify identifiers of the respective shipments (shipment identifiers). As used herein, a “shipment identifier” refers to an identifier by which status information pertaining to a shipment may be acquired (e.g., may comprise an identifier assigned to the shipment by the carrier, such as a tracking number, confirmation number, delivery configuration number, and/or the like). The carriers and vendors may be separate and independent entities. Accordingly, status information pertaining to respective transaction shipments may be maintained and/or communicated separately and/or independently from information pertaining to the corresponding vendor transactions. Moreover, transaction shipments may be handled by a plurality of different carriers, each of which may be configured to maintain and/or provide access to shipment status information in accordance with a different respective configuration. As such, in order to acquire information regarding the status of transactions with a plurality of different vendors, the user may be tasked with: a) manually access one or more transaction data sources (e.g., email accounts, text messaging accounts, instant messaging accounts, and/or other endpoints to which the vendors are configured to send transaction information); b) identify information pertaining to the respective transactions in each manually accessed transaction data source (e.g., search for messages or other data records comprising transaction information pertaining to the transactions, such as transaction and/or shipment confirmation messages); c) interpret and extract shipment information from the identified information (e.g., interpret and extract relevant transaction, shipment, and/or carrier identifiers in accordance with the representations of such information by the respective vendors); d) determine carriers corresponding to the identified shipment information; and e) manually access shipment status information maintained by each of the determined carriers (e.g., issuing a plurality of status requests, each request issued to a respective carrier and comprising an identifier of a respective transaction shipment). After completing this inefficient process, the user may obtain a plurality of shipment information sets, each having a different respective configuration (in accordance with the configuration of the carrier from which the shipment status information was acquired), and being unrelated to the transactions corresponding thereto. It may be tedious, error-prone, and inefficient for the user to attempt to manually associate the separate sets of shipment status information with corresponding transaction information, much less aggregate and/or combine the transaction and/or shipment information (or provide an interface to visualize and/or manage the combined transaction and/or shipment information).

Disclosed herein are systems, apparatus, interfaces, and/or computer-readable instructions for addressing technological problems pertaining to the aggregation, management, and/or visualization of information pertaining to user transactions including, but not limited to the specific problems described above. The disclosed embodiments may comprise configuring a computing device to perform operations of computer-implemented methods, the disclosed operations comprising: accessing transaction data pertaining to a user from a plurality of different data sources (e.g., acquiring information pertaining to transactions between the user and respective vendors from a plurality of different data sources and/or in accordance with a plurality of different access protocols), extracting shipment information from the accessed transaction data (e.g., identifying and/or retrieving shipment identifiers from the acquired transaction data), accessing shipment status data pertaining to respective transaction shipments (e.g., shipments associated with respective transactions involving the user), associating the shipment stats data with corresponding user transactions. The disclosed operations may further comprise aggregating and/or combining information pertaining to a plurality of transactions involving the user, the transactions spanning a plurality of different vendors (and/or user transaction data maintained within a plurality of different data sources). The aggregating and/or combining may include aggregating and/or combining transaction shipment status information (e.g., aggregating and/or combining the transaction data may comprise aggregating and/or combining shipment status data pertaining to shipments associated with the corresponding transactions). The aggregating and/or combining may further comprise transforming transaction and/or shipment status data represented in accordance with different respective configurations into a uniform representation. The disclosed operations may include generating a dataset comprising data pertaining to a plurality of transactions involving the user and/or corresponding transaction shipments (a transaction dataset). The disclosed dataset may comprise information pertaining to transactions between the user and a plurality of different vendors (the dataset comprising transaction data corresponding to a plurality of different configurations). The disclosed dataset may further comprise status information pertaining to transaction shipments handled by a plurality of different carriers (the dataset comprising shipment status data corresponding to a plurality of different configurations). In some embodiments, the disclosed operations further include generating a visual representation of the transaction dataset, which may comprise generating a graphical visualization of the aggregated and/or combined transaction data, the disclosed visualization comprising graphical representations of a plurality of different transactions and/or transaction shipments corresponding to a plurality of different vendors and/or a plurality of different carriers. The disclosed operations may further comprise generating interfaces (e.g., graphical user interfaces) configured to display the disclosed graphical visualizations on a computing device display.

Disclosed herein are embodiments of interfaces (e.g., graphical user interfaces) configured to display graphical visualizations of transaction datasets on a computing devise display (e.g., display graphical visualizations of transaction datasets comprising aggregated and/or combined transaction data, including graphical visualizations representing transactions between the user and a plurality of different vendors and/or corresponding transaction shipments being handled by a plurality of different carriers). The disclosed interfaces may comprise graphical user interface (GUI) components configured to represent respective transaction shipments, which may comprise graphical elements configured in accordance with a current status of the respective transaction shipments. Disclosed herein are systems, apparatus, and/or computer-readable instructions for maintaining transaction datasets to power the disclosed interfaces, which may comprise acquiring raw transaction data from a plurality of different data sources (the raw transaction data comprising information pertaining to transactions associated with a plurality of different vendors and/or transaction shipments handled by a plurality of different carriers), aggregating and/or combining the acquired transaction data into uniform transaction datasets, updating the transaction datasets (e.g., monitoring the plurality of data sources and updating the transaction datasets in response to the monitoring), and so on. Disclosed herein are systems, apparatus, and computer-readable instructions for generating instances of the disclosed interfaces (each instance corresponding to a specified transaction dataset), and transmitting data comprising the generated instance to a client computing device (for rendering and/or display thereon). Disclosed herein are systems, apparatus, and computer-readable instructions for generating embodiments of the disclosed interfaces at a client computing device. Disclosed herein are embodiments of a client-side application configured to: acquire a transaction dataset maintained by a network-accessible service (a transaction service) and generate a graphical representation of the transaction dataset at the client-computing device. The disclosed client-side application may be configured to generate the interface in response to being launched (the disclosed interface may comprise a first and/or initial interface displayed by the application).

Disclosed herein are embodiments of a computer-implemented method, comprising acquiring tracking data pertaining to transactions of a user through an electronic communication network by user of a processor of a computing system, comprising acquiring first tracking data pertaining to shipment of a first item associated with a first transaction, and acquiring second tracking data from a second carrier, the second tracking data pertaining to shipment of a second item associated with a second transaction, transmitting a graphical user interface to a client computing device through the electronic communication network. The graphical user interface may comprise a map component configured to visually represent a geographical region, a first tracking user interface element disposed on the map component, the first tracking user interface element configured to visually represent the first tracking data, and a second tracking user interface element disposed on the map component, the second tracking user interface element configured to visually represent the second tracking data. Acquiring the first tracking data may comprise retrieving transaction data through the electronic communication network by, inter alia, obtaining first transaction data pertaining to the first transaction, and obtaining second transaction data pertaining to the second transaction, extracting shipment data from the retrieved transaction data, and using the shipment data to acquire the tracking data from one or more carriers through the network. Retrieving the transaction data may comprise retrieving email messages associated with the user from one or more email systems, and extracting the transaction data from the retrieved email messages. In some embodiments, retrieving the transaction data further comprises parsing the retrieved email messages. The identifying may comprise evaluating one or more rules, such as text matching rules, sender rules, subject rules, content rules, and/or the like. In some embodiments, the identifying comprises applying one or more classifiers to the retrieved email messages, comprising one or more of a machine learning classifier, a Bayesian classifier, and an artificial neural network. Retrieving the transaction data may comprise obtaining information pertaining to the first transaction from a first ecommerce system. Retrieving the transaction data may further comprise obtaining information pertaining to the second transaction from a second ecommerce system different from the first ecommerce system. Alternatively, or in addition, retrieving the transaction data may comprise prompting the user to provide information pertaining to one or more of the first transaction and the second transaction and/or prompting the user to configure the first ecommerce system to provide information pertaining to transactions involving the user to the computing system.

Disclosed herein are embodiments of a system, comprising a computing device comprising a processor and memory, an acquisition engine configured for operation on the processor, the acquisition engine configured to acquire transaction data pertaining to transactions involving a user from one or more data sources, the acquired transaction data comprising first transaction data pertaining to a first transaction associated with a first ecommerce platform and second transaction data pertaining to a second user transaction associated with a second ecommerce platform different from the first ecommerce platform, wherein the acquisition monitor is further configured to derive a location of a first shipment associated with the first transaction and a location of a second shipment associated with the second transaction from the acquired transaction data, and an interface engine configured for operation on the processor, the interface engine configured to generate a graphical user interface for display at a client computing device, the graphical user interface comprising a first display element and a second display element overlaid on a map, wherein a location of the first display element on the map corresponds to the determined location of the first shipment, and wherein a location of the second display element on the map corresponds to the determined location of the second shipment. In some embodiments, the acquisition engine is configured to retrieve email messages associated with the user from one or more email systems, and extract portions of the transaction data from the retrieved email messages. The acquisition engine may be configured to extract transaction data from the email messages in accordance with one or more extraction rules, the extraction rules comprising one or more of text matching rules, sender rules, subject rules, and content rules. The system may further comprise a classifier configured to distinguish email messages that pertain to transactions involving the user from others of the retrieved email messages, the classifier comprising one or more of a machine learning classifier, a Bayesian classifier, and an artificial neural network. In some embodiments, the acquisition engine is further configured to retrieve transaction data pertaining to the first transaction through a first application programming interface of the first ecommerce platform. The acquisition engine may be further configured to retrieve transaction data pertaining to the second transaction through a second application programming interface different from the first application programming interface. The acquisition engine may be configured to extract a tracking number of the first shipment from the acquired transaction data, and request shipment status data pertaining to the first shipment from a carrier by use of the tracking number.

Disclosed herein are embodiments of a non-transitory computer readable medium having stored thereon computer readable instructions that, when executed by at least one processor, cause an apparatus to perform operations, comprising acquiring data pertaining to transactions of a user with respective entities, the acquired data comprising information pertaining to a first transaction with a first ecommerce system and a second transaction with a second ecommerce system different from the first ecommerce system, retrieving shipment status data pertaining to the transactions, the shipment status data comprising first shipment data corresponding to a first shipment associated with the first transaction and second shipment data corresponding to a second shipment associated with the second transaction, and generating a graphical user interface configured for display on a computing device. The graphical user interface may comprise a map component configured to represent a geographical area, a first status element overlaid on the map component, the first status element configured to represent a first shipment associated with the first transaction, wherein a location of the first status element within the graphical user interface corresponds to a determined location of the first shipment, and a second status element overlaid on the map component, the second status element configured to represent a second shipment associated with the second transaction, wherein a location of the second status element within the graphical user interface corresponds to a determined location of the second shipment. The first status element may comprise a visual representation of one or more of the first ecommerce system, an item of the first shipment, a vendor of the item, a brand associated with the item, and an estimated arrival time of the first shipment. In some embodiments, the operations further comprise deriving the location of the first shipment from first tracking data acquired from one or more of a first carrier and the first ecommerce system, and deriving the location of the second shipment from second tracking data acquired from one or more of a second carrier different from the first carrier and the second ecommerce system, wherein the first status element further comprises a path overlaid on the map component, the path indicating a plurality of locations of the first shipment. The graphical user interface may further comprise a first transaction element comprising information pertaining to the first transaction, a second transaction element comprising information pertaining to the second transaction, and a control element configured to provide for selecting between the first transaction element and the second transaction element.

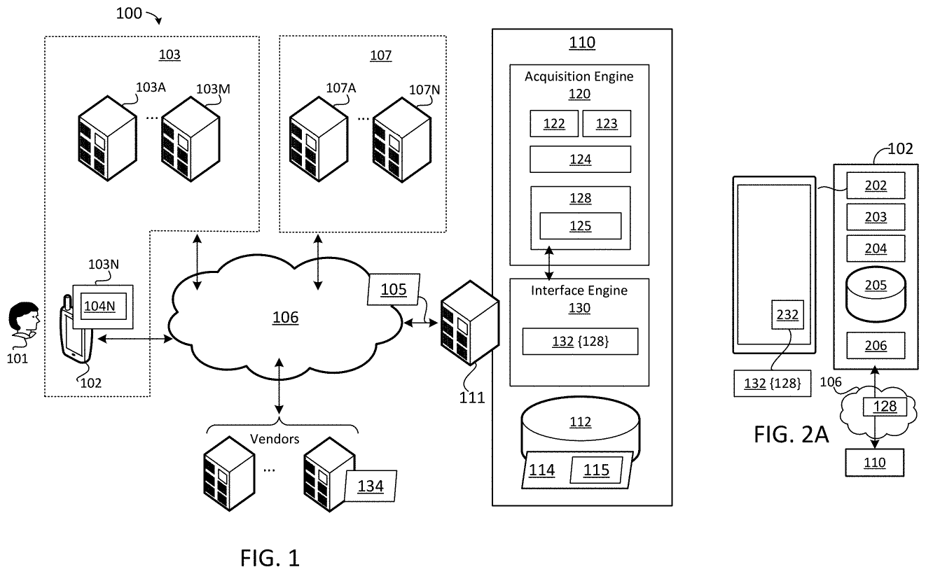

FIG. 1 is a schematic block diagram illustrating one embodiment of a system 100 for aggregating, managing, and/or visualizing transactions spanning a plurality of different vendors and/or carriers, as disclosed herein. The system 100 may comprise a transaction aggregation, management and/or visualization platform (transaction platform 110). The transaction platform 110 may comprise a network-accessible service comprising and/or embodied by one or more computing systems, such as a computing system 111. The computing system 111 may comprise one or more computing devices (e.g., one or more server computing devices, rack mounted computing devices, blade computing devices, clustered computing devices, and/or the like). Portions of the transaction service 110 (and/or services, systems, modules, agents, engines, methods, processes and/or operations disclosed herein) may comprise and/or be embodied by hardware computing resources of the computing system 111, which may include, but are not limited to: processing resources (e.g., a processor, a general-purpose processor, an application-specific processor, an Application-Specific Integrated Circuit (ASIC), a Field Programmable Gate Array (FPGA)), memory resources (e.g., volatile memory resources, random access memory (RAM), dynamic RAM, static RAM, persistent memory, battery-backed RAM, and/or the like), non-transitory storage resources (e.g., a hard drive, solid-state storage device, local storage device, network-attached storage system, and/or the like), network interface resources (e.g., a network interface device, a network interface card, and/or the like), and so on (not shown in FIG. 1 to avoid obscuring details of the illustrated embodiments).

The transaction platform 110 may comprise and/or be operatively coupled to a data store 112. The data store 112 may comprise any suitable means for persistently storing, maintaining, manipulating, and/or retrieving data, including, but not limited to one or more: storage devices, local storage devices, remote storage devices (e.g., network attached storage devices), hard disk drives, solid-state storage devices, data management systems, databases, and/or the like. As used herein, “data” refers to electronically encoded information corresponding to any suitable format, encoding, representation, and/or structure. In some embodiments, the transaction platform 110 (and/or portions thereof) may be embodied as computer-readable instructions stored on the data store 112, the computer-readable instructions configured to cause the computing system 111 to implement operations for aggregating, managing, and/or visualizing user transaction data, as disclosed herein.

The transaction platform 110 may be communicatively coupled to an electronic communication network (network 106). The network 106 may comprise any suitable means for electronic communication, including, but not limited to: an Internet Protocol (IP) network, the Internet, a wireless network, a Local Area Network (LAN), a Wide Area Network (WAN), a Virtual Private Network (VPN), a wireless network (e.g., IEEE 802.11a-n wireless network, Bluetooth® network, Near-Field Communication (NFC) network, and/or the like), a public switched telephone network (PSTN), a mobile network (e.g., a network configured to implement one or more technical standards or communication methods for mobile data communication, such as Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), High Speed Uplink Packet Access (HSUPA), Long Term Evolution (LTE), LTE-A (Long Term Evolution-Advanced), and/or the like), a combination of networks, and/or the like.

The transaction platform 110 may comprise an acquisition engine 120 configured to retrieve information pertaining to user transactions (and/or transaction shipments) from one or more data sources, which, as disclosed in further detail herein, may comprise transaction data sources 103, shipment data sources 107, vendor data sources, and/or the like. The platform 110 may further comprise an interface engine 130 configured to, inter alfa, generate interfaces configured to display visual representations of user transactions (and/or transaction shipments) pertaining to a plurality of different vendors and/or a plurality of different carriers. The interfaces may provide for managing and/or visualizing user transactions, as disclosed herein. In some embodiments, the interface engine 130 is configured to provide interfaces capable of displaying a visualization representations of a plurality of different transactions and/or a plurality of different transaction shipments that span a plurality of different vendors and/or different carriers within a single, unified map-based interface.

The acquisition engine 120 may be configured to obtain information pertaining to transactions involving respective users 101 of the transaction platform 110, extract information pertaining to respective transactions involving the users (transaction data), acquire shipment status information pertaining to transaction shipments, aggregate and/or combine the transaction data, and so on. As used herein, a “user” (a user 101) may refer to one or more of an individual, a group, an entity, an organization, a corporation, a partnership, and/or the like. A user 101 may be represented by a user record 114, which may be embodied as electronically encoded information maintained on non-transitory storage of the transaction platform 110 (e.g., within the data store 112). The transaction platform 110 may be configured to request registration information pertaining to a user 101, receive the registration information, and record the registration information within a corresponding user record 114. The transaction platform 110 may be further configured to secure user records 114 (and corresponding information pertaining to the user 101), which may comprise encrypting data transmitted on the network 106 (e.g., encrypt registration data during transport from a client computing device 102 to the transaction platform 110), encrypting data received at the transaction platform 110 (e.g., encrypting user records 114 stored within the data store 112), controlling access to user records 114, and so on.

A user record 114 may comprise any suitable information pertaining to a user 101, including, but not limited to: an identifier, contact information (e.g., email address, instant messaging address, phone number, and/or the like), preferences, settings, profile information, and/or the like. The user 101 may enter into transactions with one or more vendors. In some embodiments, the user 101 may enter into transactions through ecommerce platforms of one or more vendors (through network-accessible services, systems, and/or platforms configured to facilitate transactions, such as an on-line store, automated ordering system, and/or the like). As disclosed in further detail herein, information pertaining to transactions of the user 101 may be maintained within and/or accessible from one or more network-accessible data sources. As used herein, a network-accessible data source refers to a system, service, and/or platform configured to maintain and/or provide access to information pertaining to transactions and/or transaction shipments involving the user 101. In the FIG. 1 embodiment, information pertaining to transactions between the user 101 and one or more vendors may be maintained by and/or accessible from one or more transaction data sources 103A-N. A transaction data source 103 may comprise a service configured to receive, maintain, and/or provide access to messages pertaining to user transactions with one or more vendors. A transaction data source 103 may include, but is not limited to: an email system, messaging service, instant messaging service, text messaging service, transaction management system, account management system, a banking system, an accounting system, an ecommerce system, a storefront, and/or the like. A transaction data source 103 may comprise an account at which the user 101 receives messages pertaining to transactions corresponding to one or more vendors (e.g., may comprise an email account to which the one or more vendors are configured to send order, shipping, delivery, and/or other messages pertaining transactions therewith). Alternatively, or in addition, a transaction data source 103 may comprise and/or correspond to an ecommerce system through which the user 101 performs transactions (e.g., a transaction data source 103 may comprise a network-accessible service of a vendor). Although particular examples of transaction data sources 103 are described herein, the disclosure is not limited in this regard and could be adapted for integration with any suitable means for obtaining information pertaining to user transactions, as disclosed herein. Moreover, although FIG. 1 depicts the transaction data sources 103 and vendors as separate entities, the disclosure is not limited in this regard and could be adapted for use in configurations in which user transaction information is maintained by and/or accessible through transaction data sources 103 managed by respective vendors, and/or the like (e.g., in some embodiments, a transaction data source 103 may correspond to a network-accessible service of a vendor, or vice versa).

A user record 114 may further comprise and/or reference data pertaining to data sources associated with the user 101 (access data 115). The access data 115 registered by a user 101 for a particular data source may be configured to enable the acquisition engine 120 to access and/or extract information pertaining to transactions involving the user 101 therefrom. The access data 115 registered for a transaction data source 103 may comprise any suitable information, including, but not limited to: an identifier (e.g., a name, label, and/or other identifier associated with the transaction data source 103), access information (e.g., a network address, network port, Uniform Resource Identifier (URI), Uniform Resource Locator (URL), or other address information by which the transaction data source 103 may be accessed), access protocol information (e.g., an Application Programming Interface (API), a query and/or access mechanism supported by the transaction data source 103, such as Structured Query Language (SQL), Simple Object Access Protocol (SOAP), and/or the like), an identifier of the user 101 at the transaction data source 103 (e.g., a user name, a user identifier, an account name, an account identifier, an email address, and/or other identifier by which the user 101 is identified at the transaction data source 103), authentication data to enable the acquisition engine 120 to authenticate to and/or securely access data pertaining to the user 101 at the transaction data source 103 (e.g., an authentication credential, a token, a password, a password hash, a key, a public key, a private key, a signature, and/or the like), and so on. In one embodiment, first access data 115 registered by a user 101 may be configured to enable the acquisition engine 120 to access a first email account of the user 101 managed by a first transaction data source 103, second access data 115 registered by the user 101 may be configured to enable the acquisition engine 120 to access a second email account of the user 101 managed by a second transaction data source 103, third access data 115 may be configured to enable the acquisition engine 120 to access text messages of the user 101 managed by a third transaction data source 103, fourth access data 115 may be configured to enable the acquisition engine 120 to access an account of the user 101 with a specified vendor managed by a fourth transaction data source 103, and so on.

The acquisition engine 120 may use the access data 115 to obtain data pertaining to user transactions and/or corresponding transaction shipments (raw data transaction and/or shipment data 105). As used herein, raw transaction and/or shipment (RTS) data 105 refers to any data pertaining to a user transaction and/or transaction shipment, including, but not limited to: data pertaining to respective transactions involving the user maintained by and/or within more transaction data sources 103, data pertaining to the status of transaction shipments maintained by and/or within one or more shipment data sources 107, and/or the like. RTS data 105 may be accessed from a plurality of different data sources, each configured to maintain and/or provide access to transaction data in accordance with a respective configuration. Accordingly, RTS data 105 acquired from different data sources (e.g., different transaction and/or shipping data sources 103 and/or 107) may correspond to different respective configurations (e.g., different respective layouts, structures, schemas, encodings, formats, representations, namespaces, access protocols, and/or the like). As disclosed in further detail herein, the acquisition engine 120 may be configured to acquire information pertaining to transactions involving the user 101 (e.g., transaction data). The acquisition engine 120 may be configured to import RTS data 105 from a plurality of different data sources in accordance with different configurations, which may comprise transforming the RTS data 105 from each of a plurality of different configurations into a uniform configuration. The acquisition engine 120 may be further configured to maintain RTS data 105 acquired from different data sources (and/or having different configurations) in uniform data structures (e.g., transaction records 125). In some embodiments, the acquisition engine 120 is configured to extract, import, and/or maintain transaction records 125, each transaction record 125 comprising information pertaining to a respective transaction involving the user 101. A transaction record 125 may comprise any suitable information pertaining to a transaction, including, but not limited to: a vendor identifier (e.g., an identifier corresponding to the vendor associated with the transaction, such as a vendor name, vendor address, vendor URI, vendor URL and/or the like), a vendor transaction identifier (VTI) (an vendor-specific identifier assigned to the transaction by the vendor, such as an order number, invoice number, transaction URI, transaction URL, and/or the like), a transaction identifier (e.g., an identifier configured to uniquely identify the transaction record 125 and/or transaction represented thereby within the transaction platform 110, may comprise a combination of a vendor-specific identifiers, such as the vendor identifier and/or vendor transaction identifier, as disclosed in further detail herein), items purchased by the user 101 in the transaction (e.g., item name, Uniform Product Code (UPC), item options, item price, item quantity, URI of the item at the vendor, URL of the item at the vendor, and/or the like), information pertaining to the value of the transaction (e.g., item cost, taxes, shipping cost, insurance cost, and/or the like), receipts (e.g., information pertaining to payments remitted to the vendor pursuant to the transaction, and/or the like), information pertaining to insurance covering the transaction (if any), transaction status information (e.g., an indicator of whether the transaction is pending, in process, completed, and/or the like), and so on. A transaction record 125 may further comprise information pertaining to shipments associated with the transaction (e.g., information pertaining to transaction shipments comprising items purchased in the transaction). The information pertaining to a transaction shipment acquired from a transaction data source 103 may include, but is not limited to: an identifier of the carrier assigned to handle the shipment (e.g., a name, label, identifier, URI, URL, or other identifying information pertaining to the carrier), a shipment identifier (e.g., a identifier configured to identify the shipment at the carrier and/or access status information pertaining to the shipment, such as a tracking number, confirmation number, delivery confirmation number, and/or the like), shipment status information, and so on. In some embodiments, a transaction record 125 may comprise information pertaining to a plurality of transaction shipments, each representing a respective shipment associated with the transaction (e.g., a shipment comprising respective items purchased in the transaction).

In the FIG. 1 embodiment, the acquisition engine 120 may be configured to obtain data pertaining to transactions involving the user 101 (RTS data 105) from a plurality of transaction data sources 103A-N. Transaction data sources 103A-M may comprise third-party network-accessible systems (e.g., email systems, messaging platforms, and/or the like). The acquisition engine 120 may be further configured to obtain user transaction data from one or more “local” transaction data sources 103. As used herein, a local transaction data source 103 refers to a transaction data source 103 corresponding to a particular user 101 (and/or client computing device 102 of the user 101). In the FIG. 1 embodiment, the acquisition engine 120 may be configured to obtain RTS data 105 from transaction data source 103N, which may comprise and/or correspond to a client computing device 102 of the user 101. The transaction data source 103N may comprise data associated with one or more other transaction data sources 103A-M (e.g., may comprise data cached on the client computing device 102, such as one or more email messages corresponding to an email account of the user 101 managed by another one of the transaction data sources 103A-M). Alternatively, or in addition, the transaction data source 103N may comprise data produced and/or maintained on the client computing device 102, such as data pertaining to transactions executed by the user 101 on the computing device 102.

In some embodiments, a transaction data source 103 may be configured to maintain information pertaining to the user 101 in one or more data records. As used herein, a data record may comprise any suitable collection of electronically encoded information, including, but not limited to: a message, an email message, an instant message, a text message, a data structure, unstructured data (e.g., a data blob), an object, a data record, a transaction record, a database record, JavaScript Object Notation (JSON) data, HyperText Markup Language (HTML) data, eXtensible Markup Language (XML) data, and/or the like. The acquisition engine 120 may be configured to: access data records maintained by respective data sources (e.g., transaction data sources 103A-N), identify information pertaining to transactions involving the user 101 within one or more of the accessed data records, extract RTS data 105 from the identified data records, and import the RTS data 105 into the transaction platform 110. The acquisition engine 120 may access data records managed by a data source (e.g., transaction data source 103) using any suitable means including, but not limited to: requesting data records from the data source (e.g., sending requests to the data source through the network 106), querying the data source (e.g., submitting queries to the data source through the network 106), utilizing a data access interface provided by the data source (e.g., a data access API), searching the data source, reading data records and/or metadata from a storage system associated with the data source, and/or the like. Identifying information pertaining to a user transaction within a data record may comprise interpreting, searching, parsing, and/or analyzing the data record. The extracting may comprise retrieving RTS data 105 corresponding to the identified information pertaining to the user transaction from the data record. Importing the RTS data 105 may comprise incorporating the RTS data 105 into one or more transaction records 125. The importing may comprise generating one or more transaction records 125, updating one or more transaction records 125, and/or the like.

In some embodiments, the acquisition engine 120 may be configured to identify and/or extract RTS data 105 from a transaction data source 103 use of pre-determined extraction rules 122. The extraction rules 122 may comprise any suitable means for accessing, identifying and/or extracting electronically encoded information from a transaction data source 103 and/or data record(s) managed thereby. The extraction rules 122 may comprise and/or be embodied by computer-readable instructions, configuration data, classification data, classification criteria, and/or the like. The extraction rules 122 may comprise filter criteria configured to identify data records, of a plurality of data records, that comprise (or are likely to comprise) information pertaining to a user transaction. The extraction rules 122 may be further configured to distinguish and/or exclude data records that do not comprise (or are unlikely to comprise) information related to user transactions. The extraction rules 122 may further comprise parsing instructions configured to enable the acquisition engine 120 to interpret data managed by respective data sources (e.g., data records), identify RTS data 105 therein, and/or extract the identified RTS data 105. An extraction rule 122 may specify keywords, phrases, terms, and/or patterns that are indicative of user transaction data (e.g., keywords, phrases, terms, and/or patterns in the title, subject line, body, and/or metadata of email messages that relate to user transactions). By way of non-limiting example, an extraction rule 122 may specify that email messages having a subject line of “order confirmation” or “shipment notification” (or are from an address corresponding to a particular pattern, such as “orders@vendor.com”) comprise transaction data, and may further specify location(s) within the data record from which corresponding RTS data 105 may be extracted therefrom. Alternatively, or in addition, one or more of the extraction rules 122 may correspond to a machine learning classifier, such as a Bayesian classifier, a neural network, and/or the like. The extraction rule 122 may be configured to classify data records as transaction related or non-transaction related (and/or classify data records as comprising particular types of transaction data and/or as comprising transaction data at specified locations). In some embodiments, the extraction rules 122 may be configured to identify and/or parse data records corresponding to particular transaction types and/or transactions pertaining to particular vendors. By way of further non-limiting example, a first extraction rule 122 may be configured to identify and extract RTS data 105 from data records (e.g., email messages) associated with a first vendor, a second extraction rule 122 may be configured to identify and extract RTS data 105 from data records (e.g., email messages) associated with a second vendor, and a third extraction rule 122 may be configured to identify and extract RTS data 105 from data records accessed directly from a specified vendor (through an API provided by the specified vendor). Although particular examples of extraction rules 122 are described herein, the disclosure is not limited in this regard and could be adapted to utilize any suitable means for identifying and/or extracting RTS data 105 from electronically encoded information (e.g., data records maintained by and/or accessed from respective transaction data sources 103).

As disclosed above, each data source (e.g., each transaction data source 103A-N) may be configured to maintain data pertaining to user transactions in accordance with a respective configuration (e.g., a respective layout, structure, schema, encoding, format, representation, namespace, and/or the like), and may make such data records accessible in accordance with a respective protocol (e.g., a specified data access mechanism, API, query language, and/or the like). Accordingly, the acquisition engine 120 may be configured to access transaction data in accordance with a plurality of different protocols, and extract RTS data 105 corresponding to a plurality of different configurations.

In some embodiments, the acquisition engine 120 may comprise and/or be communicatively coupled to an integration module 123, which may comprise and/or be embodied by computer-readable instructions (and/or other configuration data) configured to enable the acquisition engine 120 to import transaction data from a plurality of different data sources. The integration module 123 may enable the acquisition engine 120 to: access, query, and/or retrieve data managed by a plurality of different data sources (in accordance with different data access protocols supported by the respective data sources, as disclosed herein); interpret, parse, and/or analyze data corresponding to a plurality of different configurations; identify, retrieve, and/or extract RTS data 105, and incorporate the extracted RTS data 105 into the transaction platform 110.

As disclosed above, data sources may be configured to manage data in accordance with respective configurations (native configurations). The native configuration of a data source may define one or more of a layout, structure, schema, encoding, format, representation, namespace, and/or other aspects of data accessed, queried, retrieved, and/or extracted therefrom. Accordingly, extracting data from different data sources may comprise accessing, querying, retrieving, interpreting, parsing, analyzing, and/or extracting data in accordance with different native configurations of the different data sources, and RTS data 105 extracted from the different data sources may correspond to the native configurations of the respective data sources (e.g., RTS data 105 extracted from a first data source may comprise data corresponding to a first configuration and RTS data 105 extracted from a second data source may comprise data corresponding to a second configuration, different from the first configuration). The integration module 123 may be configured to interpret data managed by a plurality of different data sources (in accordance with different respective configurations). The integration module 123 may be further configured to reconfigure native RTS data 105, which may comprise converting the RTS data 105 from a native configuration to a target configuration. The target configuration may comprise a uniform configuration for information pertaining to respective transactions, which may be adapted to represent transactions corresponding to a plurality of different vendors, associated with transaction shipments handled by a plurality of different carriers, and comprising data (RTS data 105) corresponding to a plurality of different configurations and/or extracted from a plurality of different data sources in accordance with a plurality of different access protocols. As disclosed in further detail herein, the target configuration may comprise and/or correspond to a target namespace, which may comprise a uniform namespace configured to encompass a plurality of local or native namespaces (e.g., namespaces corresponding to respective vendors, carriers, data sources, and/or the like). In the FIG. 1 embodiment, the target configuration may correspond to and/or be defined by a configuration of the transaction records 125 maintained by the acquisition engine 120, and the target namespace may correspond to identifying information assigned to and/or associated with the respective transaction records 125 (e.g., transaction and/or shipment identifiers assigned to respective transaction records 125 and/or transaction shipments). Transforming data from a native configuration to the target configuration may comprise performing one or more operations, which may include, but not limited to: remapping operations, manipulation operations, derivation operations, normalization operations, and/or the like. Remapping operations may comprise remapping selected elements and/or fields of native data (RTS data 105) to a uniform set of elements and/or fields of the target configuration (e.g., elements and/or fields of a transaction record 125). Remapping may comprise assigning uniform and/or normalized names, labels, and/or other semantic metadata to respective fields (columns or attributes). Manipulation operations may comprise manipulating respective fields, entries, and/or elements of the native data. A manipulation operation may pertain to one or more fields (columns or attributes) of the native data, and may comprise: adding, removing, splitting, joining, and/or otherwise manipulating the one or more fields. Alternatively, or in addition, a manipulation operation may pertain to one or more entries (rows or tuples) of the native data, and may comprise aggregating, combining, splitting and/or otherwise manipulating the one or more entries. In some embodiments, a manipulation operation may pertain to one or more elements of the native data (data values), and may comprise scaling, converting, transacting, transforming, replacing, and/or otherwise manipulating the one or more elements. Derivation operations may comprise deriving data corresponding to the native data, which may comprise performing calculations incorporating one or more fields (columns or attributes), entries (rows or tuples), elements (data values), and/or the like. A derivation operation may comprise deriving data for a new field (a new column or attribute), an existing field, a combination of fields, an existing entry, a combination of entries, and/or the like.

Normalization operations may comprise manipulating the structure and/or contents of the native data (e.g., identifiers, fields, and/or elements, and/or the like), such that the resulting data may be referenced, queried, and/or managed in accordance with uniform identifiers, fields, and/or elements (may be maintained within uniform transaction records 125). Normalization operations may further comprise translating RTS data 105 from one or more local or native namespaces to a uniform namespace. The uniform namespace may correspond to the transaction records 125 maintained within the transaction platform 110, which may comprise RTS data 105 pertaining to transactions corresponding to a plurality of different vendors and/or transaction shipments being handled be a plurality of different carriers, which may be accessed and/or extracted from a plurality of different data sources in accordance with a plurality of different protocols and/or configurations. The transaction records 125 maintained by the acquisition engine 120 may, therefore, comprise information pertaining to a plurality of different namespaces (native or local namespaces). As used herein, “native” or “local” namespaces refer to namespaces associated with RTS data 105 accessed, extracted, and/or imported into the transaction platform 110, as disclosed herein, which may include, but are not limited to: a plurality of data source namespaces (namespaces corresponding to respective data sources), a plurality of vendor namespaces (namespaces corresponding to respective vendors), a plurality of carrier namespaces (namespaces corresponding to respective carriers), and/or the like. RTS data 105 pertaining to a transaction between a user 101 and a particular vendor (and/or a transaction shipment being handled by a specified carrier) may correspond to the native namespace of the particular vendor, the specified carrier, the data source from which the RTS data 105 was extracted, and/or the like; RTS data 105 may comprise: a VTI corresponding to the namespace of the particular vendor (an identifier assigned to a transaction by the particular vendor and by which the particular vendor references the transaction, e.g., a vendor transaction identifier, as disclosed herein), a vendor-specific user name (an name or other identifier by which the particular vendor references the user 101, which may differ from an identifier used to reference the user 101 within the transaction platform 110), a carrier shipment identifier (CSI) (an identifier assigned to the shipment by the carrier and by which the carrier tracks the shipment and/or provides access to status data pertaining to the shipment), a carrier-specific receiver name (e.g., an identifier assigned to the receiver of the shipment, which may differ from a name and/or identifier of the user 101 within the transaction platform), and/or the like.

As disclosed above, importing RTS data 105 may comprise implementing normalization operations to translate the RTS data 105 from one or more of a plurality of different native namespaces into the uniform namespace corresponding to the transaction records 125 maintained within the transaction platform 110. The normalization operations may comprise translating native data from one or more native namespaces into the uniform namespace (and/or deriving identifying information corresponding to the uniform namespace from identifying information of the RTS data 105, such as names, qualified names, identifiers, and/or the like). The normalization operations may, therefore, comprise associating RTS data 105 with global or uniform identifying information. As used herein, “global” or “uniform” identifying information refers to names, qualified names, identifiers, and/or other identifying information corresponding to the uniform namespace (e.g., capable of being identified, referenced, queried, searched, indexed, and/or managed within the uniform namespace). In some embodiments, the normalization operations may comprise determining uniform transaction identifiers (transaction identifiers) from information corresponding to a vendor-specific native namespace. The normalization operations may comprise determining a transaction identifier corresponding to the uniform namespace from a combination of a vendor-specific VTI and another identifier. In some embodiments, determining transaction identifiers for RTS data 105 pertaining to transactions corresponding to respective vendors may comprise combining VTI assigned by the respective vendors with identifiers of the respective vendors. The normalization operations may further comprising determining uniform shipment identifiers (shipment identifiers) from information corresponding to a carrier-specific native namespace (e.g., generating shipment identifiers by, inter alfa, combining CSI assigned by respective carriers with identifiers of the respective carriers). The normalizing may, therefore, comprise translating RTS data 105 from a plurality of different native namespaces into a uniform namespace, which may comprise associating RTS data 105 (and/or corresponding transaction records 125) with global and/or uniform identifiers corresponding to the uniform namespace by use of identifiers corresponding to a plurality of different native namespaces (e.g., vendor, carrier, and/or data store namespaces).

Normalizing RTS data 105 may further comprise determining whether the RTS data 105 corresponds to an existing transaction record 125 use of one or more uniform identifiers associated therewith. The determining may comprise associating the RTS data 105 with a uniform transaction identifier (a transaction identifier derived from a VTI included in the RTS data 105 and/or one or more other identifiers associated with the corresponding vendor), and determining whether an existing transaction record 125 comprises the uniform transaction identifier. Alternatively, or in addition, the determining may comprise associating the RTS data 105 with a uniform shipment identifier (a shipment identifier derived from a CSI included in the RTS data 105 and/or one or more other identifiers associated with the corresponding carrier), and searching for an existing transaction record 125 (and/or transaction shipment) comprising the uniform transaction identifier. In response to determining that the RTS data 105 corresponds to an existing transaction record 125 (and/or transaction shipment), the RTS data 105 may be incorporated therein (e.g., may be incorporated into and/or used to update the existing transaction record 125 and/or transaction shipment). In response to determining that the RTS data 105 does not correspond to an existing transaction record 125, the acquisition engine 120 may generate a new transaction record 125 (and/or transaction shipment), and incorporate the RTS data 105 therein, which may comprise one or more of: associating the new transaction record 125 with the unique transaction identifier, associating the transaction shipment with the unique shipment identifier, and/or the like. The namespace normalization operations disclosed herein may, therefore, prevent creation of duplicate transaction records 125, and/or enable transaction records 125 comprising RTS data 105 corresponding to a plurality of different native namespaces (e.g., different data source, vendor, and/or carrier namespaces) to be identified, referenced, queried, searched, accessed, and/or otherwise managed within a same, uniform namespace.

In some embodiments, the integration module 123 may be configured to implement data transforms in accordance with pre-determined integration rules, which may comprise and/or correspond to one or more of the extraction rules 122, as disclosed herein (not separately shown in FIG. 1 to avoid obscuring details of the illustrated embodiments). The integration rules may define remapping, normalization, transform, derivation, and/or other operations for accessing, extracting, and/or importing RTS data 105 from each of a plurality of data sources, each data source having a different respective native configuration. The integration rules may comprise and/or be embodied by respective integration components (e.g., libraries, computer-readable instructions, and/or the like) stored on a non-transitory storage medium, each integration component configured for integration with a respective data source and/or data source type (e.g., each configured to access, interpret, extract, and/or incorporate RTS data 105 in accordance with a respective access protocol and/or configuration).

In some embodiments, the acquisition engine 120 may be configured to monitor one or more data sources (e.g., one or more of the transaction data sources 103A-N). The monitoring may comprise accessing respective transaction data sources 103A-N (querying and/or retrieving data records therefrom), interpreting the accessed data (identifying data pertaining to user transactions), extracting RTS data 105 pertaining to the user transactions, and importing the RTS data 105 into the transaction platform 110, as disclosed herein. The acquisition engine 120 may be configured to monitor one or more of the transaction data sources 103A-M periodically (e.g., once every T hours or days). Alternatively, or in addition, the acquisition engine 120 may be configured to monitor the transaction data sources 103A-M continuously and/or in response to update requests (e.g., requests from the user 101). In some embodiments, the acquisition engine 120 may be configured to receive RTS data 105 “pushed” from one or more data sources. The acquisition engine 120 may be configured to subscribe to receive updates published by one or more transaction data sources 103A-N, which may be configured to push data updates to subscribers in response as such updates are made available. The acquisition engine 120 may be configured to selectively incorporate RTS data 105 acquired in response to the monitoring, as disclosed herein.

The acquisition engine 120 may be configured to maintain transaction records 125, the transaction records 125 configured to represent respective transactions involving the user 101. The transaction records 125 may comprise a uniform representation of transactions involving a plurality of different vendors and/or a plurality of different carriers (e.g., may comprise a target configuration to which native data pertaining to such transactions may be transformed). As disclosed above, the acquisition engine 120 may assign one or more identifiers to respective transaction records 125. The identifier(s) of a transaction record 125 may comprise a VTI (e.g., an identifier assigned to the transaction by the vendor, such as an order number, invoice number, and/or the like). Respective vendors may reference transactions using the VTI assigned thereby and, as such, may include the VTI of respective transactions in messages and/or other information pertaining to the respective transactions (e.g., may include the VTI in messages sent to the user regarding respective transactions and/or transaction shipments). The RTS data 105 extracted from respective transaction data sources 103A-N may, therefore, comprise transaction data identified by use of vendor-specific VTI, which may not be unique across different vendors. In some embodiments, the acquisition engine 120 may be configured to form unique transaction identifiers from vendor-specific information extracted from respective transaction data sources 103. The acquisition engine 120 may be configured to generate a transaction identifier by, inter alfa, combining a vendor-specific VTI with another identifier (e.g., an identifier assigned to the corresponding vendor). Although particular embodiments for uniquely identifying transactions (and/or generating unique transaction identifiers) are described herein, the disclosure is not limited in this regard and could be adapted to utilize any suitable scheme for identifying and/or naming respective transactions and/or transaction records 125.

As disclosed above, importing RTS data 105 pertaining to a transaction may comprise generating a new transaction record 125 to represent the transaction and/or updating an existing transaction record 125 corresponding to the transaction. In response to receiving RTS data 105, the acquisition engine 120 may determine whether the RTS data 105 pertains a transaction associated with an existing transaction record 125. If the RTS data 105 corresponds to an existing transaction record 125, the acquisition engine 120 may be configured to incorporate the RTS data 105 therein (e.g., update the existing transaction record 125 to include portion(s) of the RTS data 105). If the RTS data 105 does not correspond to an existing transaction record 125, the acquisition engine 120 may incorporate the RTS data 105 into a new transaction record 125. The acquisition engine 120 may determine whether the RTS data 105 corresponds to an existing transaction record 125 by, inter alfa, comparing one or more identifiers of the RTS data 105 to identifiers of one or more existing transaction records 125 (e.g., a transaction identifier derived from vendor-specific VTI, as disclosed above). By way of non-limiting example, the acquisition engine 120 may extract first RTS data 105 from a transaction data source 103 (e.g., from an “order confirmation” email message sent from a particular vendor). The “order confirmation” email message (and first RTS data 105 extracted therefrom) may reference the transaction by use of a vendor-specific VTI, which may comprise an identifier assigned to the transaction by the particular vendor. The acquisition engine 120 may import the first RTS data 105, which may comprise generating a first transaction record 125. The importing may comprise determining a unique identifier for the transactions that incorporates the vendor-specific VTI (e.g., is a combination of the VTI and identifier of the particular vendor). After generating the first transaction record 125, the acquisition engine 120 may acquire second RTS data 105 (e.g., from a “shipping confirmation” email message sent a number of days after the initial “order confirmation” email message). The “shipping confirmation” email message (and the second RTS data 105 extracted therefrom) may reference the vendor-specific VTI assigned by the particular vendor. The acquisition engine 120 may import the second RTS data 105 into the transaction platform 110, which may comprise associating the second RTS data 105 with a unique transaction identifier (e.g., by combining the vendor-specific VTI with the identifier of the particular vendor), and may use the unique transaction identifier to determine that the second RTS data 105 pertains to an existing transaction record 125 (the first transaction record 125). The second RTS data 105 may, therefore, be imported into the first transaction record 125.

As disclosed above, the acquisition engine 120 may be configured to acquire, maintain, and/or update transaction records 125 pertaining to respective transactions involving the user 101 by, inter alfa, extracting RTS data 105 from one or more transaction data sources 103A-N (in accordance with access data 115 of the user 101), and importing the data into the transaction platform 110, which may comprise incorporating the RTS data 105 into one or more transaction records 125, each transaction record 125 configured to represent a respective transaction involving the user 101. A transaction may involve one or more shipments (transaction shipments). The RTS data 105 pertaining to a transaction may comprise information pertaining to respective transaction shipments (e.g., shipment identifiers). The acquisition engine 120 may maintain information pertaining to respective transaction shipments in respective transaction records 125. The acquisition engine 120 may extract RTS data 105 comprising carrier and/or shipment identifiers of respective transaction shipments from one or more transaction data sources 103A-N, and may incorporate the RTS data 105 into the transaction platform 110, as disclosed herein. In some embodiments, the acquisition engine 120 may maintain information pertaining the shipments associated with a transaction within the transaction record 125 corresponding to the transaction (or in separate transaction shipment records that reference and/or are linked to the corresponding transaction record 125). The acquisition engine 120 may be configured to maintain any suitable information pertaining to respective transaction shipments including, but not limited to: an identifier of the carriers assigned to handle respective transaction shipments (e.g., carrier name, identifier, URI, URL, and/or the like), shipment identifiers assigned to the respective transaction shipments (e.g., carrier-specific identifiers such as tracking numbers, confirmation numbers, delivery confirmation numbers, and/or the like), and so on.

The acquisition engine 120 may be further configured to obtain status information pertaining to respective transaction shipments from one or more shipment data sources 107. As used herein, a shipment data source 107 refers to any network-accessible system, platform, and/or service configured to store, maintain, and/or provide access to shipment status data. A shipment data source 107 may comprise shipment status pertaining to a designated carrier and may be configured to provide current status data pertaining to shipments handled by the designated carrier (in reference to shipment identifiers assigned to the shipments by the carrier). Alternatively, or in addition, a shipment data source 107 may be configured to maintain status data pertaining to particular types of shipments, such as overnight shipments, international shipments, and/or the like. A shipment data source 107 may correspond to a specified type and/or range of shipment identifiers (e.g., shipment identifiers, carrier identifiers, tracking numbers, confirmation numbers, and/or the like).

The acquisition engine 120 may be configured to obtain RTS data 105 comprising shipment status information from a plurality of different shipment data sources 107 (e.g., shipment data sources 107A-N). The acquisition engine 120 may obtain and/or update status information of a transaction shipment associated with a transaction record 125 by, inter alfa, sending a request to a selected shipment data source 107 (the shipment data source 107 selected in accordance with the carrier identifier and/or shipment identifier of the transaction shipment), receiving response data from the shipment data source 107, extracting RTS data 105 from the response data, and importing the RTS data 105 into the transaction platform 110, as disclosed herein. The acquisition engine 120 may be configured to request shipment status data in accordance with any suitable protocol (e.g., in accordance with a network access protocol and/or API supported by the shipment data source 107). The acquisition engine 120 may be further configured to access, interpret, analyze, parse, extract and/or import RTS data 105 comprising shipment status information in accordance with any suitable configuration (e.g., any suitable layout, structure, schema, encoding, data representation, namespace, and/or the like). In some embodiments, the acquisition engine 120 may be configured to transform response data returned from respective shipment data sources 107A-N, as disclosed herein (e.g., transform shipment status information from a native configuration of the respective shipment data sources 107A-N to a target configuration corresponding to the transaction records 125 maintained by the acquisition engine 120). The acquisition engine 120 may be configured to obtain and/or incorporate any suitable information pertaining to transaction shipments including, but not limited to: shipment status (e.g., whether the shipment is in transit, has been delivered, is on-time, is delayed, and/or the like), current physical location, estimated time of arrival (ETA), shipment exceptions (e.g., shipment routing and/or delivery exceptions), damage reports, and/or the like.

In some embodiments, the acquisition engine 120 is configured to monitor one or more of the shipment data sources 107A-N. The acquisition engine 120 may be configured to request periodically retrieve status information pertaining to selected transaction shipments and/or transaction shipments associated with selected transaction records 125 (e.g., once very T hours and/or days). Alternatively, or in addition, the acquisition engine 120 may be configured to monitor the shipment data sources 107A-N continuously and/or in response to update requests (e.g., requests from the user 101). In some embodiments, the acquisition engine 120 may be configured to subscribe to shipment updates published by one or more shipment data sources 107A-N, as disclosed herein. The acquisition engine 120 may be configured to receive shipment status information published by one or more shipment data sources 107A-N as such updates to such shipment status information are made available.

Although FIG. 1 shows the acquisition engine 120 extracting RTS data 105 from separate data sources (e.g., separate transaction data sources 103, shipment data sources 107, vendors, and/or the like), the disclosure is not limited in this regard. In some embodiments, the acquisition engine 120 may be configured to obtain RTS data 105 from a systems, platforms, and/or services configured to provide access to both transaction and shipment status information. The acquisition engine 120 may be configured to retrieve RTS data 105 comprising transaction and/or shipment status information from an ecommerce system, the ecommerce system configured to provide information pertaining to user transactions as well as shipment status information pertaining to shipments associated with the user transactions.

The acquisition engine 120 may be further configured to update status information pertaining to respective transactions and/or transaction shipments in accordance with RTS data 105 acquired thereby. The acquisition engine 120 may be configured to mark transaction shipments as complete in response to retrieving shipment status data indicating that the transaction shipment has been delivered (and/or has been accepted by the user 101). The acquisition engine 120 may be further configured to mark transaction records 125 as complete in response to determining that each transaction shipment thereof is complete (and/or in response to transaction data indicating completion of the transaction from the user 101, the vendor, a transaction data source 103, and/or the like).

The acquisition engine 120 may be further configured to generate and/or maintain transaction datasets 128 for respective users 101. Maintaining a transaction dataset 128 for a user may comprise maintaining and/or updating transaction records 125 pertaining to transactions involving the user 101. The transaction dataset 128 for user 101 may comprise transaction records 125 pertaining to active transactions involving the user 101. As used herein, an “active” transaction record 125 refers to a transaction record 125 pertaining to a transaction that has not been completed (and/or has not been marked as complete). As disclosed above, the acquisition engine 120 may determine the status of respective transaction records 125 based on RTS data 105 pertaining to the transaction retrieved from one or more data sources, the user 101, vendor, and/or the like. A transaction between a user 101 and a vendor may be completed when obligations of the user 101 and/or vendor pursuant to the transaction have all been satisfied (e.g., the user 101 has made required payment(s), and items purchased from the vendor have been delivered and/or accepted by the user 101).

The transaction dataset 128 of a user 101 may comprise a plurality of transaction records 125, the transaction records 125 comprising information pertaining to transactions with a plurality of different vendors and/or transaction shipments being handled by a plurality of different carriers. The acquisition engine 120 may extract RTS data 105 comprising the transaction records 125 from a plurality of different data sources in accordance with a plurality of different data access protocols and/or mechanisms, each data source having a different respective configuration. Accordingly, maintaining the transaction records 125 (and/or transaction dataset 128) may further comprise transforming RTS data 105 extracted from the plurality of data sources in accordance with a plurality of different native configurations to a unified, target configuration (e.g., uniform transaction records 125). Maintaining the transaction records 125 and/or transaction dataset 128 may, therefore, comprise aggregating and/or combining RTS data 105 that spans a plurality of different vendors, a plurality of different carriers, a plurality of different data sources, a plurality of different data access protocols, and/or a plurality of different configurations (e.g., a plurality of different data layouts, structures, formats, schemas, encodings, representations, namespaces, and/or the like).

Maintaining the transaction dataset 128 of the user 101 may comprise monitoring one or more data sources, retrieving RTS data 105 in response to the monitoring, and updating the transaction dataset 128 in accordance with the retrieved RTS data 105, as disclosed herein. The monitoring may comprise adding new transaction records 125 to the transaction dataset 128 (in response to retrieving RTS data 105 pertaining to new transactions involving the user 101 from one or more transaction data sources 103A-N), updating existing transaction records 125 in response to retrieving RTS data 105 from one or more transaction data sources 103A-N, updating existing transaction records 125 in response to accessing RTS data 105 comprising shipment status information from one or more shipment data sources 107A-N, and so on. The monitoring may comprise marking one or more transaction shipments as complete and/or delivered (e.g., in response to importing shipment status data indicating delivery of the shipment and/or acceptance of the shipment by the user 101). The monitoring may further comprise marking one or more transaction records 125 as complete (e.g., in response to transaction data indicating that the transaction is complete and/or shipment status data indicating that each transaction shipment thereof has been delivered and/or accepted). The monitoring may, therefore, comprise adding transaction records 125 representing new transactions involving the user 101 to the transaction dataset 128 and/or removing existing transaction records 125 representing completed transactions from the transaction dataset 128.

The interface engine 130 may be configured to provide interface(s) for managing and/or visualizing transactions involving respective users 101. The interface engine 130 may be configured to power, implement, generate, and/or display an aggregated transaction and shipment interface (ATS interface 132), which may be configured to graphically display information pertaining to the transaction dataset 128 of a user 101. The ATS interface 132 may be configured to display information pertaining to a plurality of transactions involving the user 101 within a single, unified graphical user interface (GUI). The ATS interface 132 may be configured to graphically display information pertaining to a plurality of shipments, the shipments handled by a plurality of different carriers and comprising items purchased in transactions with a plurality of different vendors. In some embodiments, the interface engine 130 may be configured to implement the ATS interface 132 in conjunction with an application operating on a client computing device 102 (e.g., application 232, as disclosed in further detail herein).

The ATS interface 132 may be configured to display a transaction dataset 128 on a computing device display, such as a display of a client computing device 102. The client computing device 102 may comprise any device having processing, memory, storage, display, and/or communication resources capable of receiving and/or rendering the ATS interface 132, including, but not limited to: a personal computing device, a workstation, a mobile computing device, a laptop, a notebook, a netbook, a communication device, a smart phone, a smart watch, a personal digital assistant (PDA), and/or the like. The ATS interface 132 (and/or the other interface(s) disclosed herein) may comprise any suitable type of human-machine-interface (HMI) and/or any suitable HMI components. The ATS interface 132 may comprise a GUI configured for display at the client computing device 102. The ATS interface 132 may be embodied as computer-readable instructions stored on a non-transitory storage medium (e.g., the ATS interface 132 may be implemented by an application configured for operation on the client computing device 102 and embodied by instructions configured for execution on a processor thereof). Alternatively, or in addition, the ATS interface 132 may be rendered remotely (e.g., at the transaction platform 110) and/or embodied as markup data configured for rendering by an application operating on the client computing device 102 (e.g., a browser application).

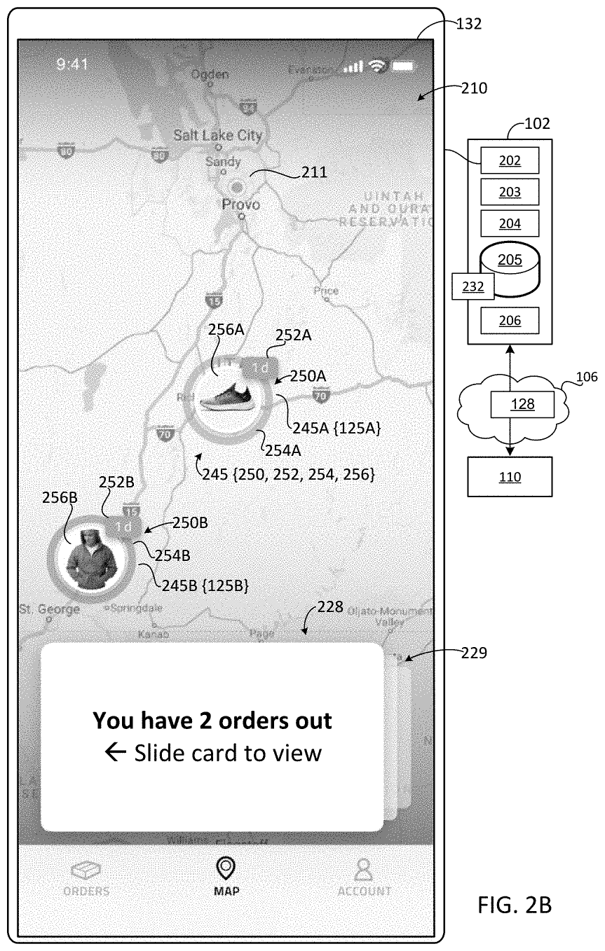

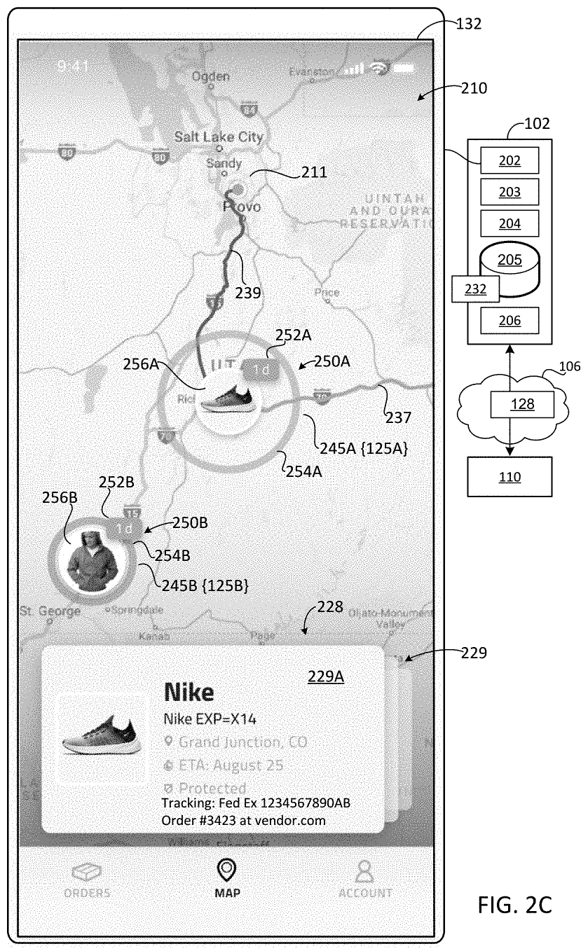

The ATS interface 132 may be configured for display on a client computing device 102. As illustrated in FIG. 2A, the client computing device 102 may comprise a portable computing device, such as a smart phone, PDA, and/or the like. The disclosure is not limited in this regard, however, and could be adapted for use with any suitable type of client computing device 102. The client computing device 102 may comprise a display 202, a processor 203 (e.g., a general-purpose processor, application-specific processor, central processing unit, and/or the like), memory 204 (e.g., volatile memory, non-volatile memory, persistent memory, random access memory (RAM), dynamic RAM, static RAM, and/or the like), non-transitory storage 205 (non-volatile storage, persistent storage, solid-state storage, and/or the like), a communication interface 206, and/or the like. In some embodiments, the ATS interface 132 may be embodied as markup data transmitted to the client computing device 102 through the network 106 (via the communication interface 206). In the FIG. 2A embodiment, the ATS interface 132 may be embodied as an application 232 configured for operation on the client computing device 102. The application 232 may be embodied as instructions stored on non-transitory storage 205 of the client computing device 102, the instructions configured to cause the computing device 102 to display the ATS interface 132 on the display 202 (and/or implement other operations disclosed herein). The application 232 may be configured to display the ATS interface 132 in response to being launched (e.g., in response to the user 101 instantiating the application 232 through an operating system and/or launcher operating on the client computing device 102). The ATS interface 132 may be the first interface displayed by the application 232 (e.g., may comprise an initial interface of the application 232).

FIG. 2B depicts one embodiment of an ATS interface 132, as disclosed herein. The ATS interface 132 may be configured for display on a client computing device 102 (a portable computing device). The ATS interface 132 may be implemented by an application 232, which may be embodied as instructions stored on non-transitory storage 205 of the client computing device 102, the instructions configured to cause the computing device 102 to display the ATS interface 132 on the display 202 (and/or implement other operations disclosed herein). The application 232 may be configured to display the ATS interface 132 when launched (the ATS interface 132 may be a first GUI interface presented by the application 232).

As disclosed above, the ATS interface 132 may be configured to graphically display information pertaining to a transaction dataset 128 of a user 101. Displaying the ATS interface 132 may comprise accessing and/or receiving a transaction dataset 128 for the user 101 (and/or selected portions thereof). Displaying the ATS interface 132 may comprise accessing the transaction dataset 128 cached on the client computing device 102. Alternatively, or in addition, displaying the ATS interface 132 may comprise retrieving the transaction dataset 128 from the transaction platform 110 (via the network 106, by use of the communication interface 206 of the client computing device 102). In some embodiments, portions of the ATS interface 132 (e.g., markup data and/or computer-readable instructions thereof) may be received from the transaction platform 110 through the network 106.

The ATS interface 132 may comprise a map component 210, which may be configured to display a graphical representation of a selected geographical area. A center of the selected geographical area may correspond to a delivery location associated with the transaction dataset 128. The delivery location may be represented by a delivery indicator 211 displayed on the map component 210. The delivery indicator 211 may correspond to a delivery address of the user 101 (e.g., the destination address for shipments of the transaction dataset 128). As disclosed in further detail herein, the geographical area covered by the map component 210 may correspond to, inter alfa, the transaction dataset 128 being displayed by the ATS interface 132 (e.g., physical locations of respective transaction shipments of the transaction dataset 128 and/or the delivery location thereof).

The ATS interface 132 may be configured to graphically represent shipments corresponding to each transaction record 125 of the transaction dataset 128. In the FIG. 2B embodiment, the ATS interface 132 may comprise one or more transaction shipment GUI components (TSG components 245), each TSG component 245 configured to represent a respective transaction shipment (e.g., a shipment associated with a specified transaction record 125, and/or transaction shipment thereof). The TSG components 245 may comprise GUI elements configured to graphically represent information pertaining to respective shipments, including, but not limited to: a current physical location of the shipment, an ETA of the shipment, a status of the shipment, items included in the shipment, and/or the like. The application 232 and/or ATS interface 132 may be configured to place TSG components 245 at selected locations within the map component 210 (map locations 250), which may be selected in accordance with the current physical location(s) of the shipments represented thereby. The map location 250 of a TSG component 245 may, therefore, indicate a current physical location of the shipment as reported by the shipment carrier and/or shipment data source 107 (as obtained by the acquisition engine 120). A TSG component 245 may further comprise one or more of: an ETA element 252 (configured to display the reported ETA of the shipment), a shipment status element 254 (comprising a graphical representation of a status of the shipment), an item display element 256 (configured to represent items included in the shipment), and/or the like. The shipment status element 254 may indicate a status of a shipment by use of a color, size, and/or intensity of the GUI element (e.g., a ring or other visual element). The ATS interface 132 may use light blue or green shipment status elements 254 to represent nominal shipments (shipments that are on-time, have no exceptions, have no reported damage, and/or the like), and may use bright red or orange shipment status elements 254 to represent shipments subject to exceptions (e.g., shipments that have been delayed, misrouted, have reported damage, and/or the like). The item display element 256 may comprise a visual representation of the contents of a shipment (e.g., a picture or other visual representation of one or more items included in the shipment).

In the FIG. 2B embodiment, the ATS interface 132 may comprise a plurality of TSG components 245, including a first TSG component 245A and a second TSG component 245B. The first TSG component 245A may be configured to represent a first shipment and the second TSG component 245B may be configured to represent a second shipment. The first shipment may pertain to a first transaction (a first transaction record 125A), may comprise items purchased from a first vendor, and may be handled by a first carrier. The second TSG component 245B may pertain to a second transaction (a second transaction record 125B), may comprise items purchased from a second vendor, and may be handled by a second carrier. The ATS interface 132 illustrated in FIG. 2A may, therefore, graphically depict transactions corresponding to a plurality of different vendors having corresponding shipments handled by a plurality of different carriers. The map location 250A of the first TSG component 245A within the map component 210 may correspond to a physical location of the first shipment (as indicated by the first transaction record 125A), and the map location 250B of the second TSG component 245B may correspond to a physical location of the second shipment (as indicated by the second transaction record 125B). The ETA of the first and second shipments may be one day (as indicated by ETA elements 252A and 252B, respectively). The shipment status element 254A of the first TSG component 245A may visually indicate that the status of the first shipment is nominal. The shipment status element 254B of the second TSG component 245B may indicate that the status of the second shipment is non-nominal (that shipping exceptions have occurred). The item display element 256A may indicate that the first shipment comprises a pair of running shoes and the item display element 256B may indicate that the second shipment comprises a hooded sweatshirt.

In some embodiments, the ATS interface 132 may be select the geographical area covered by the map component 210 (e.g., adjust the scale and/or position of the map component 210) based on, inter alfa, physical locations of shipments included in the transaction dataset 128 and/or the destination location of the shipments. The ATS interface 132 may adjust the scale of the map component 210 such that the geographical area covered thereby includes the current physical location of each shipment. Alternatively, or in addition, the ATS interface 132 may be configured to provide for manual adjustment of the scale of the map component 210, the geographical area covered by the map component 210, and/or the like.

The ATS interface 132 may further comprise a transaction control 228. The transaction control 228 may provide for selection of respective transactions (and/or transaction shipments) of the transaction dataset 128 being displayed within the ATS interface 132. In the FIG. 2B embodiment, the transaction control 228 may indicate a number of transactions being displayed in the ATS interface 132 (e.g., indicate that the transaction dataset 128 comprises 2 active transactions). In some embodiments, the transaction control 228 may provide for accessing information pertaining to selected transactions. The transaction control 228 may comprise a card interface comprising a plurality of card elements 229, each card element 229 corresponding to a respective transaction record 125. The transaction control 228 may provide for user selection of respective transactions in response slide and/or swipe inputs. In some embodiments, the transaction control 228 may be unselected (may not select any particular transaction record 125, as illustrated in the FIG. 2B embodiment). Alternatively, the transaction control 228 may be configured to designate an initially selected transaction record 125 (e.g., a most recent transaction, an oldest transaction, a transaction having exceptions, and/or the like).

In some embodiments, the interface 132 may further comprise an update control (not shown in FIG. 2B to avoid obscuring details of the illustrated embodiments). The update control may be configured to receive update inputs from the user 101. In response to an update input, the application 232 may transmit an update directive to the transaction platform 110 and, in response to the update directive, the transaction platform 110 may instruct the acquisition engine 120 to retrieve updated RTS data 105 pertaining to transactions involving the user 101 (and/or respective transaction shipments), as disclosed herein. In some embodiments, the update control may be configured to receive selective update inputs, which may correspond to specified transactions and/or transaction shipments (e.g., the update control may provide for selecting and/or may be display on a card element 229 corresponding to a particular transaction record 125 and/or a TSG component 245 corresponding to a particular transaction shipment). In response to a selective update input, the application 232 may transmit a selected update directive to the transaction platform 110 (specifying a selected transaction record 125 and/or transaction shipment) and, in response, the transaction platform 110 may instruct the acquisition engine 120 to attempt to retrieve updated RTS data 105 pertaining to the selected transaction record 125 and/or transaction shipment, as disclosed herein.

FIG. 2C depicts further embodiments of the disclosed ATS interface 132. In the FIG. 2C embodiment, the transaction control 228 is configured to select transaction record 125A (and/or the shipment corresponding to TSG component 245A). The selection may correspond to user interaction with the transaction control 228 (e.g., in response to swipe and/or slide gesture inputs to the transaction control 228). In response to the selection, the transaction control 228 may be configured to display a card element 229A comprising information pertaining to the selected transaction record 125A. The card element 229A may indicate items purchased in the transaction (e.g., may comprise a graphical depiction of one or more of the items), identify the current physical location of the transaction shipment, display the estimated delivery date for the shipment, indicate whether the transaction and/or shipment is insured (e.g., protected), and so on. The card element 229A may further specify the source of tracking information for the transaction and/or shipment (e.g., specify the shipment identifier and/or provide a link to directly access tracking information maintained by the carrier). The card element 229A may be further configured to identify the vendor associated with the transaction (e.g., vendor.com), display the VTI of the transaction (e.g., order #3432), provide a link to the transaction at the vendor, and/or the like.

The application 232 (and/or ATS interface 132) may be further configured to modify one or more GUI elements and/or components of the ATS interface 132 in response to selection of the transaction record 125A. As illustrated in FIG. 2C the modifications may comprise highlighting the TSG component 245A corresponding to the selected transaction record 125A, which may comprise increasing a size of the TSG component 245A and/or respective GUI elements thereof (e.g., expanding the shipment status element 254A). The modifications may further comprise displaying visual representations of the tracking history of transaction shipments, such as visual representations of the path by which the shipment reached its current physical location (e.g., visual history representation 237 illustrated in FIG. 2C). The modifications may further comprise displaying visual representations of a projected path of the transaction shipments, such as visual representations of the path the shipment is projected to follow to reach the destination location (e.g., projected path representation 239 illustrated in FIG. 2C). Selection of the card element 229A and/or shipment component 245A may invoke an interface configured to display further details pertaining to the transaction.

Although particular examples of GUI components and/or elements are illustrated and described herein, the disclosure is not limited in this regard and could be adapted to incorporate any suitable GUI components and/or element configured to visually represent any suitable information pertaining to transactions and/or shipments, as disclosed herein.

The application 232 may provide interfaces to enable users 101 to register with the transaction platform 110 (e.g., establish a user record 114 and access data 115, as disclosed herein). After initial launch, the application 232 may determine whether the user 101 of the application 232 has registered with the transaction platform 110. If not, the application 232 may prompt the user 101 to register, as disclosed herein. In response to determining that the user 101 has registered with the transaction platform 110 (and has established access data 115 enabling the transaction platform 110 to obtain transaction data pertaining to transactions involving the user), the application 232 may initially invoke the ATS interface 132, as disclosed herein.

Referring back to FIG. 1, the transaction records 125 maintained by the acquisition engine 120 may be configured to represent respective transactions involving the user 101, and may be embodied as electronically encoded data maintained on a non-transitory storage medium. In some embodiments, a transaction record 125 may comprise one or more of a:

| Field | Description |
|---|---|
| transaction identifier | Unique identifier of the transaction |
| | (e.g., combination of transaction |
| | identifier and vendor identifier). |
| user identifier | Identifier(s) ofuser(s) 101 associated |
| | with the transaction (may specify |
| | delivery location for transaction |
| | shipments). |
| vendor identifier | Identifier of the vendor associated with |
| | the transaction (name, URI, URL, etc.). |
| vendor transaction identifier | Identifier assigned to the transaction by |
| | the vendor (e.g., order number, invoice, |
| | and/or the like). |
| transaction items+ (items) | Information pertaining to item(s) |
| | purchased in the transaction. |
| transaction value (value) | Value of the transaction (total cost |
| | including tax, shipping, and/or the like). |
| transaction receipt+ | Information pertaining to satisfaction of |
| | the transaction by the buyer (user 101), |
| | such as payment methods and/or |
| | amounts. |
| insurance | Information pertaining to insurance |
| | covering the transaction (if any). |
| shipment records+ | Information pertaining to respective |
| | shipments associated with the |
| | transaction (transaction shipments). |
| transaction status | Indication of the status of the |
| | transaction (active, completed, |
| | disputed, etc.). |

As illustrated above, a transaction record 125 may comprise pertaining to one or more shipments (e.g., shipment records), which may be embodied as electronically encoded data maintained on a non-transitory storage medium. In some embodiments, a shipment record may comprise one or more of a:

| Field | Description |
|---|---|
| carrier identifier | Identifier of the carrier handling the |
| | shipment (name, URL, URI, etc.). |
| shipment identifier | Identifier assigned to the shipment by |
| | the carrier (e.g., tracking number). |
| shipment status | Status of the shipment (in transit, |
| | delivered, on-time, delayed, etc.). |
| shipment location | Current physical location of the |
| | shipment. |
| shipment exceptions | Information pertaining to shipment |
| | exceptions (e.g., delays, routing |
| | exceptions, etc). |
| shipment damage | Information pertaining to reported |
| | damage to the shipment. |
| destination | location to which the shipment is being |
| | delivered. |
| configuration | Information pertaining to access |
| | mechanism and/or configuration of |
| | shipment data accessible through |
| | shipment data source. |
| items+ | Items included in the shipment. |

Information pertaining to items included in respective transactions and/or shipments may be maintained in respective item records, which may be embodied as electronically encoded data maintained on a non-transitory storage medium and may include one or more of a:

| Field | Description |
|---|---|
| item identifier | Unique identifier of the item at a |
| | specified vendor (name, UPC, price, |
| | vendor identifier, etc.). |
| item options | Options pertaining to the item, such as |
| | color, size, and/or the like. |
| reorder information | Information to enable re-ordering of |
| | the item (e.g., a link to vendor, URI, URL, |
| | etc.). |

A transaction record 125 may be associated with a user 101 (as represented by corresponding user records 114). A user record 114 may be embodied as electronically encoded data maintained on a non-transitory storage medium and may include, but is not limited to a:

| Field | Description |
|---|---|
| user identifier | Unique identifier of the user 101 at the |
| | transaction platform 110 (and/or third- |
| | party identity service] |
| contact | Contact address(es) of the user (e.g., |
| | email address, instant messaging |
| | address, text messaging address, |
| | and/or the like). |
| access+ | Access data 115 configured to enable |
| | the acquisition engine 120 to obtain |
| | data pertaining to transactions of the |
| | user 101 from one or more transaction |
| | data sources 103. |
| active transactions+ | Identifier(s) of transaction records |
| | corresponding to active transactions |
| | involving the user 101. |
| recent transactions+ | Identifier(s) of transaction records |
| | corresponding to recently completed |
| | transactions involving the user 101. |
| saved transactions+ | Identifier(s) of transaction records |
| | corresponding to completed |
| | transactions saved by the user 101. |

Access data 115 may be embodied as electronically encoded data maintained on a non-transitory storage medium and may include, but is not limited to a:

| Field | Description |
|---|---|
| data source identifier | Unique identifier of the data source |
| | registration. |
| data source user identifier | Identifier of the user at the specified |
| | data source. |
| data source credential | Credential for use in authenticating to |
| | the specified data source. |
| data source protocol | Information pertaining to protocols by |
| | which data records may be accessed |
| | from the specified data source. |
| data source configuration | Information pertaining to the |
| | configuration of data maintained by |
| | specified data source. |

As disclosed above, the acquisition engine 120 may be configured to track the status of respective transactions (and/or transaction shipments). The acquisition engine 120 may be configured to monitor the status of respective transactions and/or transaction shipments. The acquisition engine 120 may maintain a transaction dataset 128 based on the monitoring.

In some embodiments, the transaction platform 110 may be further configured to maintain a recent transactions dataset comprising transaction records 125 corresponding to recently completed transactions involving the user 101. The transaction records 125 may be added to the recent transactions dataset in response to being marked as complete. Transaction records 125 may be removed from the recent transactions dataset after a pre-determined time (e.g., after T days or weeks). The interface engine 130 may be configured to generate a GUI configured to display information pertaining to the recent transactions dataset (a recent transactions GUI). The recent transactions GUI may facilitate re-ordering one or more recently purchased items. The recent transactions GUI may further comprise means for retaining selected transaction records in a saved transactions dataset. Transactions recorded in the saved transactions dataset may be retained until explicitly deleted. The interface engine 130 may be configured to generate a GUI configured to display information pertaining to the saved transactions dataset (a saved transactions GUI).

In some embodiments, the transaction platform 110 may be further comprise and/or host a vendor-side transaction component (vendor component 134). The vendor component 132 may be configured to integrate into one or more transaction interfaces of the vendor (e.g., may be configured for integration into a checkout interface of the vendor). The vendor component 134 may be configured to accept user registration data during a checkout process at the vendor (e.g.,, may provide prompts to opt-in and/or register for transaction aggregation, management, and/or visualization services, as disclosed herein). The vendor component 134 may comprise a check-box input requesting permission to share information pertaining to the user 101 maintained by the vendor with the transaction platform 110 (e.g., email, information pertaining to transactions between the user 101 and the vendor, and so on). Alternatively, or in addition, the vendor component 134 may comprise input components to prompt for and/or receive user registration information, as disclosed herein (e.g., facilitate creation of a user record 114 and/or registration of access data 115, as disclosed herein).

In some embodiments, the vendor component 134 may be further configured to present one or more offers pertaining to the transaction being established between the user 101 and the vendor (the vendor transaction). The vendor component 134 may determine a quote for insurance covering the vendor transaction. The vendor component 134 may determine the quote in accordance with information pertaining to the vendor transaction (e.g., information pertaining to items being purchased in the vendor transaction, the value of the items, the overall value of the vendor transaction, the destination of the items purchased in the vendor transaction, payment method(s) of the user 101, and/or the like). The vendor component 134 may capture information pertaining to the vendor transaction from one or more vendor interfaces (e.g., from one or more transaction interfaces of the vendor), may request transaction information from the vendor, may receive the transaction information from the vendor (e.g., the vendor may provide transaction information when instantiating the vendor component 134), and/or the like. The vendor component 134 may determine the insurance quote using any suitable mechanism including, but not limited to: applying one or more pre-determined rules or formula to derive the quote from the transaction information, sending a request for an insurance quote to the transaction platform 110, sending a request for an insurance quote to a third party (including portion(s) of the transaction information, as disclosed herein), and/or the like. The vendor component 134 may be further configured to display the insurance quote and may comprise input components by which the user 101 may purchase insurance coverage in accordance with the quote. In some embodiments, the vendor component 134 may be configured to modify the transaction in response to acceptance of the insurance quote. The modifying may comprise instructing the vendor to include the cost of the insurance in the cost of the vendor transaction. Alternatively, the vendor component 134 provide for purchasing insurance coverage in a separate transaction independent of the vendor transaction. In response to purchase of insurance coverage, the vendor component 134 may transmit information pertaining to the purchased insurance to the transaction platform 110, which may record the insurance coverage information in transaction record(s) 125 (and/or transaction shipment records) configured to represent the transaction and/or corresponding shipments.

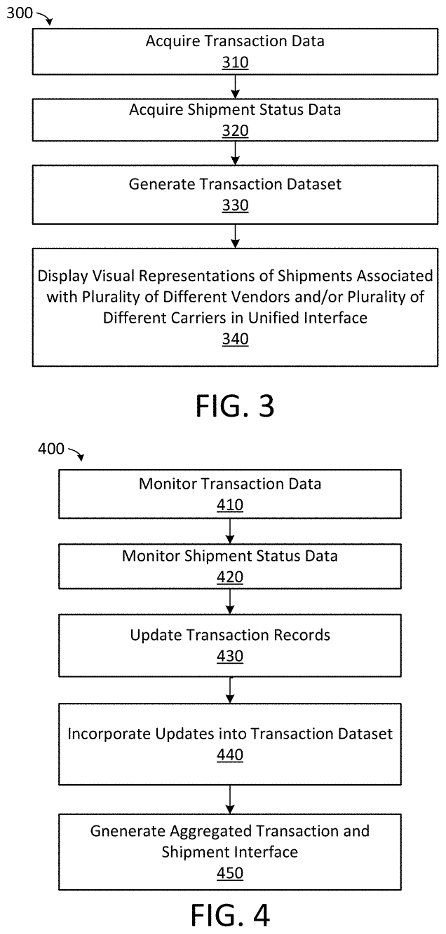

FIG. 3 is a flow diagram of one embodiment of a method 300 for managing and/or visualizing a plurality of transactions spanning a plurality of different vendors and/or a plurality of different carriers. Step 310 may comprise acquiring transaction data pertaining to a user 101, as disclosed herein. Step 310 may comprise acquiring information pertaining to transactions involving the user 101 from one or more transaction data sources 103. Step 310 may comprise using access data 115 supplied by the user 101 to access the one or more transaction data sources 103, and extract first RTS data 105 pertaining to respective user transactions therefrom. Step 310 may, therefore, comprise obtaining first RTS data 105 comprising transaction data extracted from plurality of different transaction data sources 103 in accordance with a plurality of different data access protocols, as disclosed herein. The first RTS data 105 acquired at step 310 may, therefore, comprise transaction data pertaining to transactions involving a plurality of different vendors, maintained by a plurality of different data sources, and corresponding to a plurality of different configurations. Step 310 may further comprise extracting information pertaining to shipments associated with one or more user transactions, as disclosed herein (e.g., information pertaining to respective transaction shipments). Step 310 may comprise acquiring first transaction data pertaining to a first transaction between the user and a first ecommerce system and second transaction data pertaining to a second transaction between the user and a second ecommerce system, different from the first ecommerce system.

Step 320 may comprise acquiring shipment status data corresponding to the transaction data acquired at step 320. Step 320 may comprise obtaining second RTS data 105, the second RTS data 105 comprising shipment status data retrieved from plurality of different shipment data sources 107 in accordance with a plurality of different data access protocols, as disclosed herein. The second RTS data 105 acquired at step 320 may, therefore, comprise shipment status data maintained by a plurality of different data sources, corresponding to a plurality of different configurations, and pertaining to shipments being handled by a plurality of different carriers. Step 320 may comprise acquiring tracking data pertaining to a first shipment associated with the first transaction and second tracking data pertaining to a second shipment associated with the second transaction.

Step 330 may comprise generating a transaction dataset 128 for the user 101. Step 330 may comprise incorporating transaction data acquired at step 310 and/or shipment status data acquired at step 320 into the transaction platform 110, as disclosed herein. Step 330 may comprise importing first RTS data 105 comprising transaction data pertaining to a plurality of different vendors, extracted from a plurality of different data sources in accordance with a plurality of different access protocols, and corresponding to a plurality of different native configurations into transaction records 125 corresponding to a single, uniform configuration, as disclosed herein. Step 330 may further comprise importing second RTS data 105 comprising shipment status data pertaining to shipments being handled by a plurality of different carriers, retrieved from a plurality of different data sources in accordance with a plurality of different access protocols, and corresponding to a plurality of different native configurations into transaction records 125 (and/or transaction shipment records) corresponding to a single, uniform configuration, as disclosed herein. Step 330 may, therefore, comprise aggregating and/or combining transaction and/or shipment data spanning a plurality of different vendors, a plurality of different carriers, a plurality of different data sources, a plurality of different data access protocols, and/or a plurality of different data source configurations. Step 330 may comprise translating the first RTS data 105 from first native namespaces into a uniform namespace, translating the second RTS data 105 from second native namespaces into the uniform namespace, and/or the like. The translating may comprise associating the first RTS data 105 and/or the second RTS data 105 with one or more uniform identifiers, the uniform identifiers comprising and/or derived from vendor- and/or carrier-specific identifiers included in the first RTS data 105 and/or the second RTS data 105. Step 330 may comprise deriving a transaction identifier corresponding to the uniform namespace from VTI included in one or more of the first RTS data 105 and/or the second RTS data 105 (and/or an identifier associated with a vendor associated with the VTI). Step 330 may further comprise deriving a shipment identifier corresponding to the uniform namespace from a CSI included in one or more of the first RTS data 105 and/or the second RTS data (and/or an identifier associated with a carrier corresponding to the CSI). The namespace normalization operations disclosed herein may, therefore, prevent creation of duplicate transaction records 125, and/or enable transaction records 125 comprising RTS data 105 corresponding to a plurality of different native namespaces (e.g., different data source, vendor, and/or carrier namespaces) to be identified, referenced, queried, searched, and/or otherwise managed within a single, uniform namespace.

Step 330 may further comprise monitoring one or more data sources, and updating the transaction records 125 (and/or corresponding transaction shipments) in response to the monitoring. Step 330 may comprise updating the status of one or more transaction records 125 and/or transaction shipments, which may comprise adding transaction records 125 to the transaction dataset 128, removing transaction records 125 from the transaction dataset 128, and/or the like, as disclosed herein.

Step 340 may comprise displaying a visual representation of the transaction dataset 128, as disclosed herein. Step 340 may comprise displaying visual representations of shipments associated with a plurality of different vendors and/or a plurality of different carriers in a same interface (e.g., in the disclosed ATS interface 132). Step 340 may comprise displaying the ATS interface 132 at a client computing device 102. The ATS interface 132 may be implemented by an application 232. The application 232 may be configured to display the ATS interface 132 at launch (e.g., the ATS interface 132 may be a first and/or initial interface displayed by the application 232 after being launched). Step 340 may comprise generating a graphical user interface comprising a map component configured to visually represent a geographical region. Step 340 may further include producing a first tracking user interface element (e.g., first item display element 256) and a second tracking user interface element (e.g., second item display element 256). The first tracking user interface element may be configured to represent a first shipment and, as such, may be positioned within the map in accordance with the determined location of the first shipment. The second tracking user interface element may be configured to represent a second shipment and, as such, may be positioned within the map in accordance with the determined location of the second shipment.

FIG. 4 is a flow diagram of another embodiment of a method 400 for managing and/or visualizing a plurality of transactions spanning a plurality of different vendors and/or a plurality of different carriers. Step 410 may comprise monitoring transaction data pertaining to a user 101, as disclosed herein. Step 420 may comprise monitoring shipment status data pertaining to shipments associated with transactions involving the user 101, as disclosed herein. Step 430 may comprise updating transaction records 125 in response to the monitoring of steps 410 and/or 420. Step 430 may comprise incorporating RTS data 105 acquired from respective data sources, as disclosed herein (e.g., RTS data 105 acquired from one or more transaction data sources 103, shipment data sources 107, and/or the like). Step 430 may comprise creating new transaction records 125 and/or updating existing transaction records 125. Step 430 may comprise updating one or more transaction shipments (e.g., updating shipment records of one or more transaction records 125). Step 430 may comprise marking one or more transaction shipments as complete. Step 430 may further comprise marking one or more transactions as complete. Step 440 may comprise incorporating the updates of step 430 into a transaction dataset 128 maintained for the user 101, as disclosed herein. Step 440 may comprise adding and/or removing transaction records 125 from the transaction dataset 128, such that the transaction dataset 128 comprises transaction records 125 representing active transactions involving the user 101 (transactions that are not yet complete). Step 440 may comprise adding new transaction records 125 to the transaction dataset 128 and/or removing completed transaction records 125 from the transaction dataset 128. The transaction dataset 128 may comprise RTS data 105 extracted from a plurality of different data sources, each having a respective configuration. Maintaining the transaction records 125 of the transaction dataset 128 may comprise a uniform representation of transaction data spanning a plurality of different vendors and/or a plurality of different carriers.

Step 450 may comprise generating an ATS interface 132, as disclosed herein. Step 450 may comprise generating a visual representation of the transaction dataset 128. Step 450 may, therefore, comprise generating an interface configured to visually represent the transaction dataset 128 (e.g., a visual representation of a plurality of transactions and/or transaction shipments corresponding to a plurality of different vendors and/or a plurality of different carriers within a single, unified interface). Step 450 may include configuring a map component 210 of the ATS interface 132, which may comprise configuring the map component 210 to cover a selected geographical area. The geographical area may be selected in accordance with current physical locations of one or more transaction shipments of the transaction dataset 128, as disclosed herein. Step 450 may comprise generating a plurality of TSG components 245, each TSG component 245 configured to visually represent a respective transaction shipment of the transaction dataset 128. Step 450 may further comprise configuring each TSG component 245 in accordance with a current status of the transaction shipment represented thereby, which may include, but is not limited to: setting a map location 250 of the TSG component 245 in accordance with a current physical location of the shipment, configuring the ETA element 252 in accordance with the current ETA of the shipment, configuring the shipment status element 254 in accordance with the current status of the shipment (e.g., setting the color, size, and/or intensity of the shipment status element 254, as disclosed herein), configuring the item display element 256 to visually represent one or more items included in the shipment, and so on.

Step 450 may further comprise generating a transaction control 228 for display within the ATS interface 132, the transaction control 228 comprising information pertaining to respective transactions and/or transaction shipments of the transaction dataset 128, as disclosed herein. Step 450 may include updating the ATS interface 132 in response to selection of a transaction by the transaction control 228 (e.g., in response to gesture inputs received at the transaction control 228). The updating may comprise displaying a card element 229 comprising information pertaining to the transaction and/or modifying TSG component(s) 245 configured to represent shipments of the transaction, as disclosed herein.

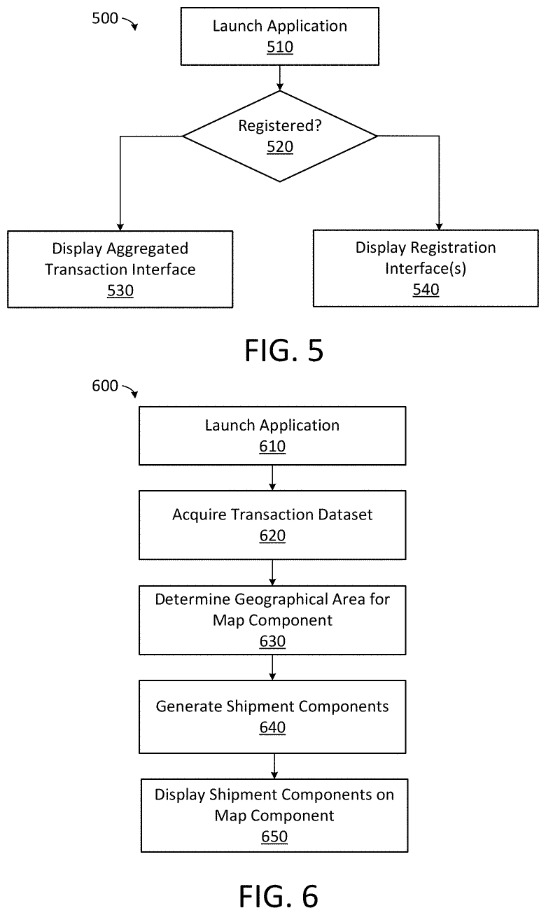

FIG. 5 is a flow diagram of another embodiment of a method 500 for managing and/or visualizing a plurality of transactions spanning a plurality of different vendors and/or a plurality of different carriers. Step 510 may comprise launching client-side executable code stored on the client computing device 102 and/or transferred from the transaction platform 110. Step 520 may comprise the application 232 determining whether a user 101 of the application 232 is registered with the transaction platform 110 (e.g., determining whether the user 101 corresponds to an existing user record 114 and/or access data 115). Step 520 may comprise attempting to authenticate the user 101 to the transaction platform 110. Alternatively, or in addition, step 520 may comprise attempting to retrieve a transaction dataset 128 corresponding to the user 101 (and/or a portion thereof) from the transaction platform 110 and/or cache storage of the client computing device 102. If the user 101 is registered with the transaction platform 110 (and/or has a transaction dataset 128), the flow may continue at step 530; otherwise, the flow may continue at step 540. Step 530 may comprise displaying the ATS interface 132, as disclosed herein. Step 530 may comprise displaying the ATS interface 132 as the initial interface of the application 232 (e.g., the ATS interface 132 may be the first GUI interface displayed by the application 232 upon being launched). Step 540 may comprise displaying one or more registration interface(s). Step 540 may further comprise prompting the user 101 to enter user registration information (e.g., access data 115) and/or securely transmitting the user registration information to the transaction platform 110, as disclosed herein. In response to registration of the user 101 at step 540, the application 232 may be configured to initially display the ATS interface 132 the next time the application 232 is launched.

FIG. 6 is a flow diagram of another embodiment of a method 600 for managing and/or visualizing a plurality of transactions spanning a plurality of different vendors and/or a plurality of different carriers. Step 610 may comprise launching the application 232 on the client computing device 102, as disclosed herein. Step 620 may comprise the application 232 acquiring a transaction dataset 128 for the user 101 of the application 232. Step 620 may comprise requesting the transaction dataset 128 from the transaction platform 110, retrieving the transaction dataset 128 from cache storage, and/or the like. Step 630 may comprise determining a geographical area corresponding to the transaction dataset 128. The geographical area may be selected to include physical locations of transaction shipments included in the transaction dataset 128, as disclosed herein. Step 630 may further comprise configuring a map component 210 in accordance with the selected geographical area. Step 640 may comprise generating TSG components 245 corresponding to each transaction record 125 (and/or shipment record) of the transaction dataset 128. Step 640 may comprise configuring each TSG component 245 to visually represent a respective transaction shipment, which may comprise configuring the map location 250, ETA element 252, shipment status element 254, and/or item display element 256 of each TSG component 245, as disclosed herein. Step 650 may comprise displaying the TSG components 245 on a visual representation of a map. Step 650 may comprise displaying the TSG components 245 on a map component 210, as disclosed herein. Step 650 may comprise displaying an ATS interface 132 on a display 202 of the client computing device 102, as disclosed herein.

What is claimed is:

1. A computer-implemented method, comprising:
acquiring tracking data pertaining to transactions of a user through an electronic communication network by user of a processor of a computing system, comprising:
acquiring first tracking data pertaining to shipment of a first item associated with a first transaction, and
acquiring second tracking data from a second carrier, the second tracking data pertaining to shipment of a second item associated with a second transaction; and
transmitting a graphical user interface to a client computing device through the electronic communication network, the graphical user interface comprising:
a map component configured to visually represent a geographical region,
a first tracking user interface element disposed on the map component, the first tracking user interface element configured to visually represent the first tracking data, and
a second tracking user interface element disposed on the map component, the second tracking user interface element configured to visually represent the second tracking data.

2. The computer-implemented method of claim 1, wherein acquiring the first tracking data comprises:
retrieving transaction data through the electronic communication network, comprising:
obtaining first transaction data pertaining to the first transaction, and
obtaining second transaction data pertaining to the second transaction;
extracting shipment data from the retrieved transaction data; and
using the shipment data to acquire the tracking data from one or more carriers through the network.

3. The computer-implemented method of claim 2, wherein retrieving the transaction data comprises:
retrieving email messages associated with the user from one or more email systems; and
extracting the transaction data from the retrieved email messages.

4. The computer-implemented method of claim 3, wherein retrieving the transaction data further comprises parsing the retrieved email messages.

5. The computer-implemented method of claim 3, the identifying comprises evaluating one or more rules, comprising one or more of text matching rules, sender rules, subject rules, and content rules.

6. The computer-implemented method of claim 3, wherein the identifying comprises applying one or more classifiers to the retrieved email messages, comprising one or more of a machine learning classifier, a Bayesian classifier, and an artificial neural network.

7. The computer-implemented method of claim 2, wherein retrieving the transaction data comprises obtaining information pertaining to the first transaction from a first ecommerce system.

8. The computer-implemented method of claim 6, wherein retrieving the transaction data further comprises obtaining information pertaining to the second transaction from a second ecommerce system different from the first ecommerce system.

9. The computer-implemented method of claim 2, wherein retrieving the transaction data comprises prompting the user to provide information pertaining to one or more of the first transaction and the second transaction.

10. The computer-implemented method of claim 2, wherein retrieving the transaction data comprises prompting the user to configure the first ecommerce system to provide information pertaining to transactions involving the user to the computing system.

11. A system, comprising:
a computing device comprising a processor and memory;
an acquisition engine configured for operation on the processor, the acquisition engine configured to acquire transaction data pertaining to transactions involving a user from one or more data sources, the acquired transaction data comprising first transaction data pertaining to a first transaction associated with a first ecommerce platform and second transaction data pertaining to a second user transaction associated with a second ecommerce platform different from the first ecommerce platform, wherein the acquisition monitor is further configured to derive a location of a first shipment associated with the first transaction and a location of a second shipment associated with the second transaction from the acquired transaction data; and
an interface engine configured for operation on the processor, the interface engine configured to generate a graphical user interface for display at a client computing device, the graphical user interface comprising a first display element and a second display element overlaid on a map, wherein a location of the first display element on the map corresponds to the determined location of the first shipment, and wherein a location of the second display element on the map corresponds to the determined location of the second shipment.

12. The system of claim 10, wherein the acquisition engine is configured to:
retrieve email messages associated with the user from one or more email systems; and
extract portions of the transaction data from the retrieved email messages.

13. The system of claim 10, The system of claim 11, wherein the acquisition engine is configured to extract transaction data from the email messages in accordance with one or more extraction rules, the extraction rules comprising one or more of text matching rules, sender rules, subject rules, and content rules.

14. The system of claim 10, further comprising a classifier configured to distinguish email messages that pertain to transactions involving the user from others of the retrieved email messages, the classifier comprising one or more of a machine learning classifier, a Bayesian classifier, and an artificial neural network.

15. The system of claim 10, wherein the acquisition engine is further configured to retrieve transaction data pertaining to the first transaction through a first application programming interface of the first ecommerce platform.

16. The system of claim 14, wherein the acquisition engine is further configured to retrieve transaction data pertaining to the second transaction through a second application programming interface different from the first application programming interface.

17. The system of claim 10, wherein the acquisition engine is further configured to:
extract a tracking number of the first shipment from the acquired transaction data; and
request shipment status data pertaining to the first shipment from a carrier by use of the tracking number.

18. A non-transitory computer readable medium having stored thereon computer readable instructions that, when executed by at least one processor, cause an apparatus to perform operations, comprising:
acquiring data pertaining to transactions of a user with respective entities, the acquired data comprising information pertaining to a first transaction with a first ecommerce system and a second transaction with a second ecommerce system different from the first ecommerce system;
retrieving shipment status data pertaining to the transactions, the shipment status data comprising first shipment data corresponding to a first shipment associated with the first transaction and second shipment data corresponding to a second shipment associated with the second transaction; and
generating a graphical user interface configured for display on a computing device, comprising:
a map component configured to represent a geographical area,
a first status element overlaid on the map component, the first status element configured to represent a first shipment associated with the first transaction, wherein a location of the first status element within the graphical user interface corresponds to a determined location of the first shipment, and
a second status element overlaid on the map component, the second status element configured to represent a second shipment associated with the second transaction, wherein a location of the second status element within the graphical user interface corresponds to a determined location of the second shipment.

19. The non-transitory computer readable medium of claim 18, wherein the first status element comprises a visual representation of one or more of the first ecommerce system, an item of the first shipment, a vendor of the item, a brand associated with the item, and an estimated arrival time of the first shipment.

20. The non-transitory computer readable medium of claim 18, the operations further comprising:
deriving the location of the first shipment from first tracking data acquired from one or more of a first carrier and the first ecommerce system; and
deriving the location of the second shipment from second tracking data acquired from one or more of a second carrier different from the first carrier and the second ecommerce system,
wherein the first status element further comprises a path overlaid on the map component, the path indicating a plurality of locations of the first shipment.

21. The graphical user interface of claim 18, further comprising:
a first transaction element comprising information pertaining to the first transaction;
a second transaction element comprising information pertaining to the second transaction; and
a control element configured to provide for selecting between the first transaction element and the second transaction element.
